(19) United States
(12) Patent Application Publication
(10) Pub. No.: US 2024/0034885 A1
(43) Pub. Date: Feb. 1, 2024

(54) NEAR-INFRARED (NIR) TRANSPARENT NEUTRAL BLACK SOLID SOLUTION PIGMENT

(71) Applicant: SUN CHEMICAL B.V., Weesp (NL)

(72) Inventors: Nikolay VINOKUROV, Ludwigshafen (DE); Paul Pascal ROQUETTE, Ludwigshafen am Rhein (DE); Paul BROWN, Basel (CH); Till VOGEL, Ludwigshafen am Rhein (DE); Andres Carlos GARCIA ESPINO, Ludwigshafen am Rhein (DE)

(73) Assignee: SUN CHEMICAL B.V., Weesp (NL)

(21) Appl. No.: 18/256,579

(22) PCT Filed: Dec. 20, 2021
(86) PCT No.: PCT/EP2021/086869

§ 371 Date: Jun. 8, 2023

(30) Foreign Application Priority Data
Dec. 21, 2020 (EP) 20216081.8

(51) Int. Cl. C09B 67/22; C09B 5/62; C09D 5/33; C09D 5/00; C09D 7/41

(52) U.S. Cl. CPC C09B 67/0034; C09B 5/62; C09D 5/004; C09D 5/002; C09D 7/41

(57) ABSTRACT

The present invention relates to a solid solution comprising (a) at least one compound according to formula (I), and (b) at least one compound according to formula (II), or at least one compound according to formula (III), or a mixture of at least one compound according to formula (II) and at least one compound according to formula (III), wherein R₁ and R₂ may, independently of one another, stand for —(CH₂)ₙ—X, wherein X stands for hydrogen, methyl, a C₁-C₅ alkoxyl, hydroxy, phenyl, C₁-C₅ alkylphenyl, C₁-C₅ alkoxyphenyl, hydroxyphenyl, halogenated phenyl, pyridyl, C₁-C₅ alkylpyridyl, C₁-C₅ alkoxypyridyl, halogenated pyridyl, pyridylvinyl or naphthyl; wherein n stands for 0, 1, 2, 3, 4 or 5; R₃ and R₄ may, independently of one another, stand for phenylene, C₁-C₅ alkylphenylene, C₁-C₅ alkoxyphenylene, hydroxyphenylene, halogenated phenylene, pyridinediyl, C₁-C₅ alkylpyridinediyl, C₁-C₅ alkoxy-pyridinediyl, halogenated pyridinediyl, anthraquinonediyl or naphthalenediyl, wherein the 2 nitrogen atoms bound to R₃ according to formula (II) and (III) form a 5-membered or a 6-membered heterocycle with 2 atoms of an aromatic ring of R₃; wherein the 2 nitrogen atoms bound to R₄ according to formula (II) and (III) form a 5-membered or a 6-membered heterocycle with 2 atoms of an aromatic ring of R₄; X₁ to X₈ may, independently from one another, stand for hydrogen, C₁-C₅ alkyl, C₁-C₅ alkoxy, hydroxy, phenyl or halide. The present invention further relates to a process for producing the solid solution. Furthermore, the present invention relates to a solid solution obtainable or obtained according to said process and to the use of the inventive solid solution, in particular as a NIR transparent black colorant in a NIR non-absorbing component.

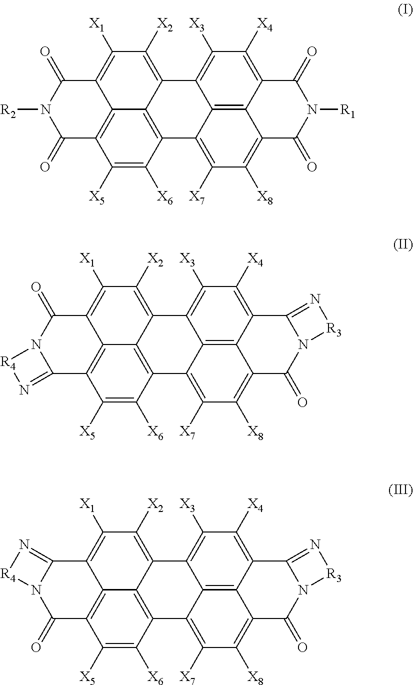

### TECHNICAL FIELD

The present invention relates to a solid solution comprising at least one compound according to formula (I)

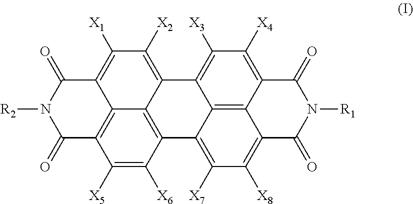

and at least one compound according to formula (II), or at least one compound according to formula (III), or a mixture of at least one compound according to formula (II) and at least one compound according to formula (III)

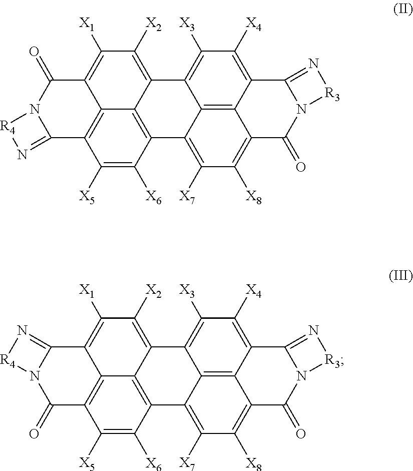

The present invention further relates to a process for producing the solid solution. The present invention furthermore relates to a solid solution obtainable or obtained according to said process and to the use of the inventive solid solution, in particular as a near-infrared (NIR) transparent black colorant in a near-infrared (NIR) non-absorbing component.

### INTRODUCTION

For many coating applications such as automotive coatings, aerospace coatings, industrial coatings and architectural coatings, dark colors, such as black are particularly desirable for aesthetic purposes. As black pigments, there have been conventionally used carbon black such as PBk 6, PBk7 or inorganic black pigments like PBk 11. However, dark colored coatings have historically been susceptible to absorption of near-infrared radiation because they often rely on the use of pigments, such as carbon black, that absorb near-infrared radiation in addition to visible radiation. Near-infrared (NIR) radiation, i.e., electromagnetic radiation having a wavelength of from 700 to 2500 nanometers, constitutes over 50% of the solar energy that reaches the earth's surface. Heat is a direct consequence of the absorption of near-infrared (NIR) radiation. As a result, dark colored coatings have historically been susceptible to substantially increased temperatures, particularly on sunny days, which is often undesirable for many reasons.

Additionally, recent advances have been made in technologies utilizing near-infrared NIR, related to self-driving (“autonomous”) vehicles and other objects in a vehicle's surroundings including markings that are detectable by a sensor mounted on the autonomous vehicle.

Traditional carbon black pigments strongly absorb near-infrared (NIR) LiDAR signals used by autonomous vehicles for navigation. Low LiDAR signal return erodes object detection capability particularly for darker colored objects that contain higher levels of carbon black. Automotive coating formulations using near-infrared (NIR) transparent or reflective functional black pigments deliver superior signal response thereby improving object detection. However, black pigments are vital formulation tools but traditional carbon black pigments largely absorb LiDAR's signal. Dark and black shades with good LiDAR response are desired.

In addition, in WO2018/081613 attempts have been made to obtain methods and systems for increased NIR detection distance of an object coated with a NIR reflective coating using a physical mixture of different perylene-based pigments. However, even though such pigment blend of two (or more) pigments achieve the required coloristics, the coloristic obtained from the dispersed mixed pigments can vary significantly depending on the dispersion conditions used and the required tint level in the target color. In order to achieve the required coloristic at all concentrations when using a physical mixture of two (or more) pigments, generally the ratios of the blended components will need to be adjusted to achieve the same neutral coloristic.

U.S. Pat. No. 7,083,675 describes perylene-based pigments as solid solutions produced by calcination at high temperatures and in vacuum or in an inert gas atmosphere. However, these pigments have low-crystallinity and insufficient coloristic performance. Additionally, due to the process conditions at high temperatures under inert gas atmosphere these pigments cannot be used conventionally in the field of organic pigments.

A solid solution defines a crystal where two or more molecules are contained within the same crystal structure and this structure is identical to that adopted by one of the molecules alone.

The molecule in the greatest concentration, whose crystal structure dictates that of the solid solution, is termed as the host. The other molecule is termed as the guest. In any event, a solid solution can be differentiated from a physical mixture of the components by examination of their X-ray diffraction patterns. In a physical mixture, the X-ray diffraction patterns characteristic of each of the components are identifiable, and the pattern of the mixture is the sum of the patterns of each of the components. The X-ray diffraction pattern of a solid solution, however, is clearly distinguishable from those of its components; some of the X-ray lines of the components may disappear and new ones appear.

There, however, is a need for improved coloristics and functionality in a near-infrared (NIR) transparent black perylene-based pigment. In particular, there remains the problem of providing near-infrared (NIR) transparent black perylene-based pigment in which the coloristic obtained from the dispersed mixed pigments does not significantly depend on the dispersion conditions used and the required pigment levels in the target color. There is a need to achieve the required coloristic at all concentrations without varying the ratios of the blended components.

### DETAILED DESCRIPTION

It was therefore an object of the present invention to provide an improved solid solution containing single near-infrared (NIR) transparent black perylene-based pigment, which provides colorations having advantageous performance properties, especially neutral coloristics, very low chroma and high black values (M_{C} color depending and M_{Y} non-color depending). Thus, it has surprisingly been found that a solid solution containing a near-infrared (NIR) transparent black perylene-based pigment provide colorations having advantageous performance properties especially neutral coloristics, very low chroma and high black values (M_{C} color depending and M_{Y} non-color depending).

Therefore, the present invention relates to a solid solution comprising (a) at least one compound according to formula (I)

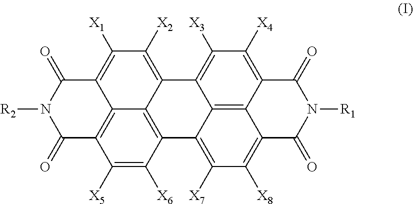

and (b) at least one compound according to formula (II), or at least one compound according to formula (III), or a mixture of at least one compound according to formula (II) and at least one compound according to formula (III)

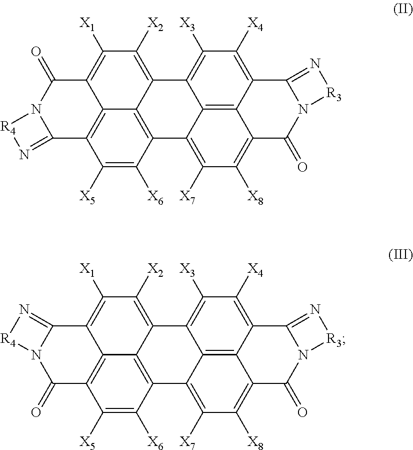

wherein R₁ and R₂ may, independently of one another, stand for —(CH₂)ₙ—X, wherein X stands for hydrogen, methyl, a C₁-C₅ alkoxyl, hydroxy, phenyl, C₁-C₅ alkylphenyl, C₁-C₅ alkoxyphenyl, hydroxyphenyl, halogenated phenyl, pyridyl, C₁-C₅ alkylpyridyl, C₁-C₅ alkoxypyridyl, halogenated pyridyl, pyridylvinyl or naphthyl; wherein n stands for 0, 1, 2, 3, 4 or 5; R₃ and R₄ may, independently of one another, stand for phenylene, C₁-C₅ alkylphenylene, C₁-C₅ alkoxyphenylene, hydroxyphenylene, halogenated phenylene, pyridinediyl, C₁-C₅ alkylpyridinediyl, C₁-C₅ alkoxypyridinediyl, halogenated pyridinediyl, anthraquinonediyl or naphthalenediyl, wherein the 2 nitrogen atoms bound to R₃ according to formula (II) and (III) form a 5-membered or a 6-membered heterocycle with 2 atoms of an aromatic ring of R₃; wherein the 2 nitrogen atoms bound to R₄ according to formula (II) and (III) form a 5-membered or a 6-membered heterocycle with 2 atoms of an aromatic ring of R₄; X₁ to X₈ may, independently from one another, stand for hydrogen, C₁-C₅ alkyl, C₁-C₅ alkoxy, hydroxy, phenyl or halide.

According to the present invention it is preferred that the 2 nitrogen atoms bound to R₃ according to formula (II) and (III) form a 5-membered heterocycle with 2 adjacent atoms of an aromatic ring of R₃; and the 2 nitrogen atoms bound to R₄ according to formula (II) and (III) form a 5-membered heterocycle with 2 adjacent atoms of an aromatic ring of R₄.

According to the present invention, it is preferred that X stands for C₁-C₅ alkoxyphenyl or phenyl and n is 1 or 2; R₃ and R₄ are independently of one another phenylene, C₁-C₅ alkylphenylene, C₁-C₅ alkoxyphenylene, halogenated phenylene or naphthalenediyl; X₁ to X₈ stand for independently of one another hydrogen or halide.

According to the present invention, it is preferred that X stands for methoxyphenyl or phenyl and n is 1 or 2; R₃ and R₄ are independently of one another phenylene, methyl-phenylene, methoxyphenylene, chloro-phenylene, dichloro-phenylene or naphthalenediyl; X₁ to X₈ stand for hydrogen.

According to particular and preferred embodiments of the present invention, wherein R₁ and R₂ may, independently from one another, stand for —CH₂C₆H₄OCH₃ or —CH₂CH₂C₆H₅; R₃ and R₄ may, independently of one another, stand for phenylene, 4-chloro-phenylene, naphthalenediyl or 4,5-dichloro-phenylene; X₁ to X₈ stand for hydrogen.

According to the present invention, it is preferred that R₁ is R₂ or that R₃ is R₄ or that R₁ is R₂ and R₃ is R₄, preferably that R₁ is R₂ and R₃ is R₄.

According to the present invention, it is preferred that X stands for 4-methoxyphenyl and n is 1; R₃ and R₄ stand for phenylene; X₁ to X₈ stand for hydrogen.

According to the present invention, it is preferred that X stands for 4-methoxyphenyl and n is 1; R₃ and R₄ are naphthalenediyl; X₁ to X₈ are hydrogen.

According to the present invention, it is preferred that X stands for 4-methoxyphenyl and n is 1; R₃ and R₄ stand for 4-chloro-phenylene; X₁ to X₈ stand for hydrogen.

According to the present invention, it is preferred that X stands for 4-methoxyphenyl and n is 1; R₃ and R₄ stand for 4,5-dichloro-phenylene; X₁ to X₈ stand for hydrogen.

According to the present invention, it is preferred that X stands for phenyl and n is 2; R₃ and R₄ stand for phenylene; X₁ to X₈ stand for hydrogen.

According to the present invention, it is preferred that X stands for phenyl and n is 2; R₃ and R₄ stand for naphthalenediyl; X₁ to X₈ stand for hydrogen.

According to the present invention, it is preferred that X stands for phenyl and n is 2; R₃ and R₄ stand for 4-chloro-phenylene; X₁ to X₈ stand for hydrogen.

According to the present invention, it is preferred that that the solid solution of the present invention exhibits a color non-depending black value M_{Y} in the range of from 200 to 350, preferably in the range of from 220 to 330, more preferably in the range of from 230 to 300, more preferably in the range of from 242 to 280 and a color depending black value M_{C} in the range of from 200 to 350, preferably in the range of from 220 to 330, more preferably in the range of from 230 to 300, more preferably in the range of from 242 to 280, M_{Y} and M_{C} being determined according to DIN EN ISO 18314-3.

According to the present invention, it is preferred that the solid solution of the present invention is a black near-infrared (NIR) neutral transparent pigment of neutral hue, wherein near-infrared represents a wavelength in the range of from 700 to 2500 nanometers, and wherein transparent represents a transparency in the near-infrared region having a transmission of >70%, preferably of 80% at 1000 nm.

According to the present invention, it is preferred that the solid solution of the present invention exhibits a TSR value over a reflective substrate (TSR value>80%) of a value of >25%, preferably of a value of >33%.

According to the present invention, it is preferred that the solid solution of the present invention exhibits a near-infrared reflectance over a reflective substrate (>90% reflectance) at 905 nm of a value of >65%, preferably of a value of >75%, over a reflective substrate (>70% reflectance) at 1550 nm of a value of >50%, preferably of a value of >60%.

According to the present invention, it is preferred that the solid solution of the present invention has a particle size in the range of from 5 to 1000 nm, preferably in the range of from 10 to 500 nm, more preferably in the range of from 20 to 200 nm.

According to the present invention, it is preferred that the solid solution of the present invention comprises, preferably consists of, one crystal modification, more preferably comprises, more preferably consists of, one crystal modification in an amount of more than 80 weight-%, more preferably in an amount of more than 90 weight-%, based on the total weight of the solid solution.

According to the present invention, it is preferred that in the solid solution, the weight ratio of the at least compound of formula (I) relative to the at least one compound according to formula (II) or to the at least one compound according to formula (III) or to the mixture of at least one compound according to formula (II) and at least one compound according to formula (III), weight((I)):weight((II)(II)), is in the range of from 60:40 to 99:1, preferably in the range of from 65:35 to 95:5, more preferably in the range of from 70:30 to 90:10, such as in the range of from 70:30 to 80:20 or in the range of from 75:25 to 85:15 or in the range o from 80:20 to 90:10.

According to the present invention, it is preferred that from 80 to 100 weight-%, preferably from 85 to 100 weight-%, more preferably from 90 to 100 weight-%, more preferably from 95 to 100 weight-%, more preferably from 99 to 100 weight-%, more preferably from 99.5 to 100 weight-% of the solid solution consist of (a) the at least one compound according to formula (I) and (b) the at least one compound according to formula (II), or the at least one compound according to formula (III), or the mixture of the at least one compound according to formula (II) and the at least one compound according to formula (III).

According to the present invention, it is preferred that the solid solution comprises (a) one compound according to formula (I) and (b) one compound according to formula (II), or one compound according to formula (III), or a mixture of one compound according to formula (II) and one compound according to formula (III).

Alternatively, it is preferred according to the present invention that from 80 to 100 weight-%, preferably from 85 to 100 weight-%, more preferably from 90 to 100 weight-%, more preferably from 95 to 100 weight-%, more preferably from 99 to 100 weight-%, more preferably from 99.5 to 100 weight-% of the solid solution consist of (a) one compound according to formula (I) and (b) one compound according to formula (II), or one compound according to formula (III), or a mixture of one compound according to formula (II) and one compound according to formula (III). According to the present invention, it is preferred that in the solid solution a compound according to formula (IV):

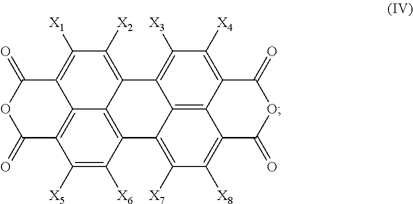

wherein X₁ to X₈ are independently from one another hydrogen, C₁-C₅ alkyl, C₁-C₅ alkoxy, hydroxy, phenyl or halide, is excluded.

The present invention further relates to a process for producing a solid solution, comprising (i) providing a mixture comprising (a) at least one compound according to formula (I)

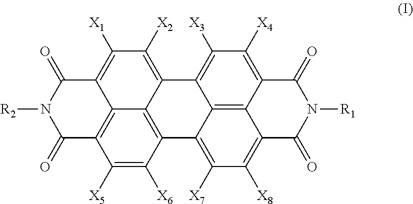

and (b) at least one compound according to formula (II), or at least one compound according to formula (III), or a mixture of at least one compound according to formula (II) and at least one compound according to formula (III)

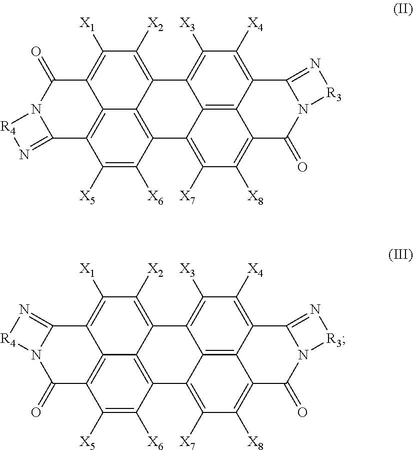

wherein R₁ and R₂ may, independently of one another, stand for —(CH₂)ₙ—X, wherein X stands for hydrogen, methyl, a C₁-C₅ alkoxyl, hydroxy, phenyl, C₁-C₅ alkylphenyl, C₁-C₅ alkoxyphenyl, hydroxyphenyl, halogenated phenyl, pyridyl, C₁-C₅ alkylpyridyl, C₁-C₅ alkoxypyridyl, halogenated pyridyl, pyridylvinyl or naphthyl; wherein n is 0, 1, 2, 3, 4 or 5; R₃ and R₄ may, independently of one another, stand for phenylene, C₁-C₅ alkylphenylene, C₁-C₅ alkoxyphenylene, hydroxyphenylene, halogenated phenylene, pyridinediyl, C₁-C₅ alkylpyridinediyl, C₁-C₅ alkoxypyridinediyl, halogenated pyridinediyl, anthraquinonediyl or naphthalenediyl, wherein the 2 nitrogen atoms bound to R₃ according to formula (II) and (III) form a 5-membered or a 6-membered heterocycle with 2 atoms of an aromatic ring of R₃; wherein the 2 nitrogen atoms bound to R₄ according to formula (II) and (III) form a 5-membered or a 6-membered heterocycle with 2 atoms of an aromatic ring of R₄; X₁ to X₈ may, independently from one another, stand for hydrogen, C₁-C₅ alkyl, C₁-C₅ alkoxy, hydroxy, phenyl or halide; (ii) subjecting the mixture provided according to (i) to mechanical treatment; (iii) adding water to the mixture obtained from (ii); (iv) subjecting the mixture obtained from (iii) to solid-liquid separation; (v) washing the solids obtained from (iv) with at least one suitable washing agent; (vi) drying the solids obtained from (v), obtaining the solid solution.

According to the present invention, it is preferred that providing a mixture according to (i) comprises adding at least one suitable acid or solvent to the mixture, wherein the at least one suitable acid is preferably one or more of polyphosphoric acid and sulfuric acid, wherein more preferably, the at least one suitable acid comprises, more preferably is sulfuric acid, and wherein the at least one solvent comprises, preferably is water.

According to the present invention, it is preferred that providing a mixture according to (i) is carried out at a temperature of the mixture in the range of from 30 to 120° C., preferably in the range of from 40 to 110° C., more preferably in the range of from 50 to 100° C.

According to the present invention, it is preferred that providing a mixture according to (i) is carried out at a temperature of the mixture in the range of from 30 to 80° C., preferably in the range of from 40 to 70° C., more preferably in the range of from 45 to 60° C., the process preferably further comprises adding at least one suitable base, solvent or sodium hydrosulfite to the mixture, wherein the at least one suitable base is preferably one or more of sodium hydroxide and potassium hydroxide, wherein more preferably, the at least one suitable base is sodium hydroxide, and wherein the at least one solvent comprises, preferably is water, more preferably wherein the process further comprises adding at least one suitable oxidant, wherein more preferably, the at least one suitable oxidant is one or more of oxygen or hydrogen peroxide.

According to the present invention, it is preferred that the mechanical treatment according to (ii) comprises one or more kneading and milling, wherein kneading comprises coextrusion, salt kneading, single-shaft kneading and double-shaft kneading and wherein milling comprises wet milling, ball milling, bead milling, vibration milling, planetary milling and attritor milling.

According to the present invention, it is preferred that the mechanical treatment according to (ii) comprises, preferably is kneading, wherein said kneading is carried out at a temperature of the mixture in the range of from 40 to 120° C., preferably in the range of from 45 to 90° C., more preferably in the range of from 50 to 90° C., the process preferably further comprising, either directly before and/or during kneading, adding one or suitable solvent or one or more of sodium chloride, sodium sulfate and anhydrous aluminium sulfate, preferably sodium chloride to the mixture to be kneaded, wherein more preferably the weight ratio of one or more of sodium chloride, sodium sulfate and anhydrous aluminium sulfate relative to the mixture provided according to (i), is in the range of from 20:1 to 1:1, preferably 15:1 to 2:1, more preferably 10:1 to 2:1, more preferably 8:1 to 2:1, more preferably 6:1 to 2:1, and more preferably 4:1 to 2:1, and wherein the at least one solvent is preferably one or more ethylene glycol, diethylene glycol, diacetone alcohol, dimethylformamide, glycerine, triethylene glycol, dipropylene glycol, ethylene glycol monobutyl ether, methyl ethyl ketone, cyclohexanone, dimethylacetamide, Nmethylpyrrolidone, butyl acetate, glycerol triacetate, sulfolane, xylene, tetrahydrofuran, butanol, water and dimethyl sulfoxide, wherein more preferably, the at least one solvent comprises, more preferably is diethylene glycol, diacetone alcohol, dimethylformamide, xylene, butanol, water and glycerine.

According to the present invention, it is preferred that the mechanical treatment according to (ii) further comprises, either directly before and/or during kneading, adding at least one or more of a synergist comprising sulfonic and carboxylic acid derivatives of perylene, indanthrone, phthalocyanine and diketopyrrolopyrrole, preferably in an amount of 1 to 15 weight-%, more preferably 1 to 5 weight-%, based on the total weight of the kneaded mixture, and/or a natural or synthetic resin comprising esters and salts of abietic acid, hydrated or partially hydrogenated or dimerised rosin, preferably in an amount of 1 to 50 weight-%, more preferably 5 to 30 weight-%, based on the total weight of the kneaded mixture; or polysorbate-type nonionic surfactant comprising an ester or a mixture of esters formed from fatty acids, like lauric or sebacic acid, and polyols, like sorbitan monolaureate or dibutylsebacate, preferably in an amount of 1 to 50 weight-%, more preferably 5 to 30 weight-%, based on the total weight of the kneaded mixture, to the mixture to be kneaded.

Alternatively, it is preferred according to the present invention that the mechanical treatment according to (ii) comprises, preferably is milling, wherein said milling is carried out at a temperature of the mixture in the range of from 40 to 120° C., preferably in the range of from 45 to 90° C., more preferably in the range of from 50 to 90° C., the process preferably further comprising, either directly before and/or during milling, adding one or more of sodium chloride, sodium sulfate and anhydrous aluminium sulfate, preferably sodium chloride to the mixture to be milled.

According to the present invention, it is preferred that the process further comprises, directly after milling, adding at least one suitable acid or solvent to the milled mixture under stirring at a temperature of the mixture in the range of from 40 to 200° C., preferably in the range of from 45 to 150° C., more preferably in the range of from 50 to 120° C., wherein the at least one suitable acid is preferably one or more of polyphosphoric acid and sulfuric acid, wherein more preferably, the at least one suitable acid comprises, more preferably is sulfuric acid, and wherein the at least one solvent is preferably one or more ethylene glycol, diethylene glycol, diacetone alcohol, dimethylformamide, glycerine, triethylene glycol, dipropylene glycol, ethylene glycol monobutyl ether, methyl ethyl ketone, cyclohexanone, dimethylacetamide, N-methylpyrrolidone, butyl acetate, glycerol triacetate, sulfolane, xylene, tetrahydrofuran, butanol, water and dimethyl sulfoxide, wherein more preferably, the at least one solvent comprises, more preferably is diethylene glycol, diacetone alcohol, dimethylformamide, xylene, butanol, water and glycerine.

According to the present invention, it is preferred that wet milling is carried out with steel balls, silicon/aluminum/zirconium oxide beads, glass beads, ceramic beads and agate balls, preferably having a diameter in the range from 0.1 to 5 cm, and wherein milling is wet milling and wherein wet milling is carried out in water or in a mixture of water and at least one suitable organic solvent and optionally at least one suitable base, wherein more preferably, the at least one suitable solvent comprises, more preferably is methanol, ethanol, propanol, isopropanol butanol, pentanol, ethylene glycol, diethylene glycol, triethylene glycol and dipropylene glycol, and wherein more preferably, the at least one suitable base comprises, more preferably is, sodium hydroxide, potassium hydroxide, sodium hydroxide, lithium hydroxide and benzyl trimethylammonium hydroxide.

Further, it is preferred according to the present invention that the mechanical treatment according to (ii) further comprises, either directly before and/or during milling, adding one or more of a synergist, preferably in an amount of 1 to 15 weight-%, more preferably 1 to 5 weight-%, based on the total weight of the milled mixture, and/or a natural or synthetic resin comprising esters and salts of abietic acid, hydrated or partially hydrogenated or dimerised rosin, preferably in an amount of 1 to 50 weight-%, more preferably 5 to 30 weight-%, based on the total weight of the milled mixture or polysorbate-type nonionic surfactant comprising an ester or a mixture of esters formed from fatty acids, like lauric or sebacic acid, and polyols, like sorbitan monolaureate or dibutylsebacate, preferably in an amount of 1 to 50 weight-%, more preferably 5 to 30 weight-%, based on the total weight of the milled mixture, to the mixture to be milled.

According to the present invention, it is preferred that the at least one or more of a synergist comprises sulfonic and carboxylic acid derivatives of perylene, indanthrone (PB 60), copper, aluminium or zinc phthalocyanine, quinacridone (PV 19, PR 202), dioxazine (PV 23, PV 37, PB 80) and diketopyrrolopyrrole (PR 254, PR 255).

Further, it is preferred according to the present invention that the at least one or more of a synergist comprises sulfonic and carboxylic acid derivatives of perylene, indanthrone, copper, aluminium or zinc phthalocyanine, quinacridone, dioxazine and diketopyrrolopyrrole, wherein the sulfonic and carboxylic acid derivatives of perylene, indanthrone, copper, aluminium or zinc phthalocyanine, quinacridone, dioxazine and diketopyrrolopyrrole may, independently of one another, be mono- or polysubstituted by —COO— M⁺, —COOR′₅, —CONR′₅R′₆, —COO— N⁺R′₅R′₆R′₇R's, —SO₂NR′₅R′₆, —CH₂NR′₅R′₆, —CH₂N⁺R′₅R′₆R′₇R′₈R′₅—COO— and/or —CH₂R′₉, benzoyl and may additionally stand for mono- or polysubstituted by C₁-C₁₂-alkyl, C₁-C₆-alkoxy, nitro and/or halogen; R′₅, R's, R′₇, R's may, independently of one another, stand for hydrogen; C₁-C₁₂-alkyl or C₂-C₁₂-alkenyl whose hydrocarbon chain may in each case be interrupted by one or more —O—, —S—, —NR′₉—, —CO— or —SO₂— moieties, and/or be mono- or polysubstituted by hydroxyl, halogen, aryl, C₁-C₄-alkoxy and/or acetyl; C₃-C₈-cycloalkyl whose carbon skeleton may be interrupted by one or more —O—, —S—, —NR′₁₀— or —CO— moieties, and/or be substituted by acetyl; R′₉ stands for phthalimidyl; R′₁₀ stands for hydrogen or C₁-C₈-alkyl; M⁺ stands for hydrogen or a metal cation, in particular as alkali metal cation, more preferably sodium or potassium. Suitable synergists are described in EP0636666B1, preferably perylene derivative of formula I, WO2005078023A2, preferably perylene derivative of formulae Ia′ and 1b′; WO91/02034A1, preferably perylene derivative of formula I; EP2316886A1, preferably compounds of formulae DS-1, DS-2, DS-3; EP504922A1, preferably compounds of formula I; US2012018687A1, preferably compounds of formula I; US20050001202A1, preferably compounds of formulae I to VII; EP0700420B1, preferably compounds of formulae I to VII or CN110591445A, preferably compounds of formulae I, IA, IB, II, III, IV.

According to the present invention, it is preferred that the solid-liquid separation according to (iv) comprises one or more of centrifugation and filtration, more preferably filtration.

According to the present invention, it is preferred that the at least one suitable washing agent according to (v) comprises, more preferably is water, wherein the solids obtained from (iv) are preferably washed until the water obtained from washing exhibits a conductivity of at most 100 microSiemens/cm.

Furthermore, it is preferred according to the present invention that drying the solids obtained from (v) is carried out in a gas atmosphere, said gas atmosphere preferably being one or more of nitrogen, air, and lean air and preferably having a temperature in the range of from 50 to 150, more preferably from 50 to 95° C., more preferably 60 to 90° C., more preferably 70 to 85° C.

According to the present invention, it is preferred that in the process n, X, R₁, R₂, R₃, R₄, X₁ to X₈ and specific combinations thereof are as defined for a solid solution as described in any of the particular and preferred embodiments described in the present description.

According to the present invention, it is preferred that the solid solution is the solid solution as described in any of the particular and preferred embodiments described in the present description.

The present invention further relates to a solid solution obtainable or obtained according to the process as described in any of the particular and preferred embodiments described in the present description.

According to the present invention, it is preferred that the solid solution obtainable or obtained according to the process as described in any of the particular and preferred embodiments described in the present description, wherein R₁ and R₂ may, independently of one another, stand for —(CH₂)ₙ—X, wherein X stands for hydrogen, methyl, a C₁-C₅ alkoxyl, hydroxy, phenyl, C₁-C₅ alkylphenyl, C₁-C₅ alkoxyphenyl, hydroxyphenyl, halogenated phenyl, pyridyl, C₁-C₅ alkylpyridyl, C₁-C₅ alkoxypyridyl, halogenated pyridyl, pyridylvinyl or naphthyl; wherein n is 0, 1, 2, 3, 4 or 5; R₃ and R₄ may, independently of one another, stand for phenylene, C₁-C₅ alkylphenylene, C₁-C₅ alkoxyphenylene, hydroxyphenylene, halogenated phenylene, pyridinediyl, C₁-C₅ alkylpyridinediyl, C₁-C₅ alkoxypyridinediyl, halogenated pyridinediyl, anthraquinonediyl or naphthalenediyl, wherein the 2 nitrogen atoms bound to R₃ according to formula (II) and (III) form a 5-membered or a 6-membered heterocycle with 2 atoms of an aromatic ring of R₃; wherein the 2 nitrogen atoms bound to R₄ according to formula (II) and (III) form a 5-membered or a 6-membered heterocycle with 2 atoms of an aromatic ring of R₄; X₁ to X₈ may, independently from one another, stand for hydrogen, C₁-C₅ alkyl, C₁-C₅ alkoxy, hydroxy, phenyl or halide.

The present invention further relates to a solid solution comprised in one or more of a thermoplastic, elastomeric, crosslinked or inherently crosslinked polymer, preferably a polyolefin, polyamide, polyurethane, polyacrylate, polyacrylamide, polyvinyl alcohol, polycarbonate, polystyrene, polyester, polyacetal, a natural or synthetic rubber and a halogenated vinyl polymer in an amount from 0.01 weight-% to 70 weight-% based on the total weight of the polymer.

The present invention further relates to a solid solution comprised in one or more of a coating composition which is applied to the surface of the substrate, preferably a thermoplastic, elastomeric, crosslinked or inherently crosslinked polymer which is in the form of a film or coating applied to the surface of a substrate, or in the form of a fiber, sheet or other moulded or shaped article.

The present invention furthermore relates to a solid solution comprised in one or more of a coating composition, a light detection and ranging (LiDAR) device, a near-infrared (NIR) nonabsorbing component, a photovoltaic component, a heat management component, a thermal insulation component, a coloring paint, a printing ink, a recyclable plastic article, a biodegradable mulch, a toner, a charge-generating material, a color filter, a LC display and a security print component.

The present invention further relates to a solid solution for use as a component in one or more of a coating composition, a light detection and ranging (LiDAR) device, a near-infrared (NIR) non-absorbing component, a photovoltaic component, a heat management component, a thermal insulation component, a coloring paint, a printing ink, a recyclable plastic article, a biodegradable mulch, a toner, a charge-generating material, a color filter, a LC display and a security print component.

Yet, in another embodiment, the present invention relates to the use of a solid solution as a component of one or more of a coating composition, a light detection and ranging (LiDAR) device, a near-infrared (NIR) non-absorbing component, a photovoltaic component, a heat management component, a thermal insulation component, a coloring paint, a printing ink, a recyclable plastic article, a biodegradable mulch, a toner, a charge-generating material, a color filter, a LC display and a security print component.

Alternatively, the present invention relates to a coating composition and/or a light detection and/or a ranging (LiDAR) device and/or a near-infrared (NIR) non-absorbing component and/or a photovoltaic component and/or a heat management component and/or a thermal insulation component and/or a coloring paint and/or a printing ink and/or a recyclable plastic article and/or a biodegradable mulch and/or a toner and/or a charge-generating material and/or a color filter and/or a LC display and/or a security print component, comprising a solid solution as described in any of the particular and preferred embodiments described in the present description.

The present invention further relates to a multilayer coating comprising a primer coating comprising a solid solution as described in any of the particular and preferred embodiments described in the present description and a white pigment or a reflective pigment having a reflectance of >50% in the range of 700 to 2500 nm in a weight ratio of from 1:99 to 99:1, preferably from 1:95 to 95:1; a basecoat comprising a black, preferably comprising a solid solution as described in any of the particular and preferred embodiments described in the present description, colour, metallic or interference pigment; and optionally a clear topcoat.

The present invention further relates to the use of a solid solution as described in any of the particular and preferred embodiments described in the present description for producing one or more of a coating composition, a light detection and ranging (LiDAR) device, a near-infrared (NIR) non-absorbing component, a near-infrared (NIR) non-absorbing component, a photovoltaic component, a heat management component, a thermal insulation component, coloring paint, a printing ink, a plastic, a recyclable plastic article, a biodegradable mulch, a toner, a chargegenerating material, a color filter, a LC display and a security print component.

The present invention furthermore relates to a to a method for producing one or more of a coating composition, a light detection and ranging (LiDAR) device, a near-infrared (NIR) nonabsorbing component, a photovoltaic component, a heat management component, a thermal insulation component, a coloring paint, a printing ink, a plastic, a recyclable plastic article, a biodegradable mulch, a toner, charge-generating material, a color filter, a LC display and a security print component, the method comprising providing and processing a solid solution as in any of the particular and preferred embodiments described in the present description.

The present invention further relates to a method for identifying an item, wherein said item comprises a feature comprising an effective amount of a solid solution as described in any of the particular and preferred embodiments described in the present description, wherein said feature is recorded under irradiation by electromagnetic waves of wavelength from 700 to 2500 nm, and the feature's image is used for identifying the item.

The present invention furthermore relates to a method for laser welding an article, wherein a solid solution as described in any of the particular and preferred embodiments described in the present description, is incorporated into a polymeric composition which is in contact with a surface of a meltable substrate containing a near infra-red absorbing material, then near infra-red radiation preferably from a laser of wavelength in the range from 700 to 2500 nm is passed through the layer containing the solid solution as described in any of the particular and preferred embodiments described in the present description to the underlying substrate generating enough heat at the point of irradiation to melt together the two materials.

The present invention furthermore relates to a method of identifying a recyclable plastic article comprising a solid solution as described in any of the particular and preferred embodiments described in the present description with a laser signal of a wavelength in the range from 700 to 2500 nm.

The present invention further relates to the use of a solid solution as described in any of the particular and preferred embodiments described in the present description as a near-infrared (NIR) transparent colorant which can replace near-infrared (NIR) absorbing black pigments in a coating or object to increase the signal to noise ratio in near-infrared (NIR) radiation detection.

The present invention further relates to the use of a solid solution as described in any of the particular and preferred embodiments described in the present description for a LiDAR detection with a laser signal of a wavelength in the range from 700 to 2500 nm.

The present invention furthermore relates to the use of a solid solution as described in any of the particular and preferred embodiments described in the present description as a nearinfrared (NIR) transparent black colorant in a near-infrared (NIR) non-absorbing component.

The present invention further relates to a coating comprising a solid solution as described in any of the particular and preferred embodiments described in the present description and at least one organic pigment and/or at least one inorganic pigment and/or an effect pigment, wherein the organic pigment is selected from the group consisting of Color Index (C.I.) Pigment Yellow 109, 110, 139, 151, 154; C.I. Pigment Orange 61, 64, 69, 73; C.I. Pigment Red 122, 179, 202, 254, 264, 272, 282; C.I. Pigment Brown 29; C.I. Pigment Violet 19, 23, 37; C.I. Pigment Blue 15:1, 15:2, 15:3, 15:4, 15:6, 60, 80; C.I. Pigment Green 7, 36; C.I. Pigment Black 31, 32, Spectrasense™ Black K 0087 (Lumogen® Black K 0087) and pigment preparations of said pigments; and wherein the inorganic pigment is selected from the group consisting of C.I. Pigment Yellow 53, 184, C.I. Pigment Brown 24, 29, 33, 35, C.I. Pigment Blue 28, 36, C.I. Pigment Green 17, 26, 50, C.I. Pigment Black 12, 30 and pigment preparations of said pigments.

The present invention is further illustrated by the following set of embodiments and combinations of embodiments resulting from the dependencies and back-references as indicated. In particular, it is noted that in each instance where a range of embodiments is mentioned, for example in the context of a term such as “A . . . concretizing any one of embodiments 1 to 4”, every embodiment in this range is meant to be explicitly disclosed for the skilled person, i.e. the wording of this term is to be understood by the skilled person as being synonymous to “A . . . concretizing any one of embodiments 1, 2, 3, and 4”. Further, it is explicitly noted that the following set of embodiments is not the set of claims determining the extent of protection, but represents a suitably structured part of the description directed to general and preferred aspects of the present invention.

According to an embodiment 1, the present invention relates to a solid solution comprising
(a) at least one compound according to formula (I)

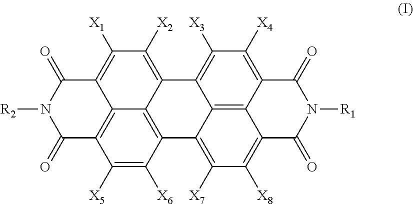

and
(b) at least one compound according to formula (II), or at least one compound according to formula (III), or a mixture of at least one compound according to formula (II) and at least one compound according to formula (III)

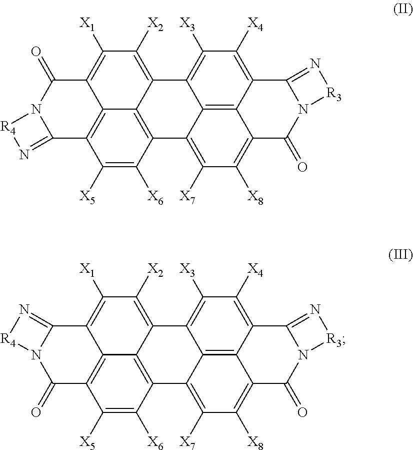

wherein R₁ and R₂ are independently of one another —(CH₂)ₙ—X, wherein X is hydrogen, methyl, a C₁-C₅ alkoxyl, hydroxy, phenyl, C₁-C₅ alkylphenyl, C₁-C₅ alkoxyphenyl, hydroxyphenyl, halogenated phenyl, pyridyl, C₁-C₅ alkylpyridyl, C₁-C₅ alkoxypyridyl, halogenated pyridyl, pyridylvinyl or naphthyl; wherein n is 0, 1, 2, 3, 4 or 5; R₃ and R₄ are independently of one another phenylene, C₁-C₅ alkylphenylene, C₁-C₅ alkoxyphenylene, hydroxyphenylene, halogenated phenylene, pyridinediyl, C₁-C₅ alkylpyridinediyl, C₁-C₅ alkoxypyridinediyl, halogenated pyridinediyl, anthraquinonediyl or naphthalenediyl, wherein the 2 nitrogen atoms bound to R₃ according to formula (II) and (III) form a 5-membered or a 6-membered heterocycle with 2 atoms of an aromatic ring of R₃; wherein the 2 nitrogen atoms bound to R₄ according to formula (II) and (III) form a 5-membered or a 6-membered heterocycle with 2 atoms of an aromatic ring of R₄; X₁ to X₈ are independently from one another hydrogen, C₁-C₅ alkyl, C₁-C₅ alkoxy, hydroxy, phenyl or halide.

A preferred embodiment 2 concretizing embodiment 1, wherein X is C₁-C₅ alkoxyphenyl or phenyl and n is 1 or 2; R₃ and R₄ are independently of one another phenylene, C₁-C₅ alkylphenylene, C₁-C₅ alkoxyphenylene, halogenated phenylene or naphthalenediyl; X₁ to X₈ are independently of one another hydrogen or halide.

A preferred embodiment 3 concretizing embodiment 1 or 2, wherein X is methoxyphenyl or phenyl and n is 1 or 2; R₃ and R₄ are independently of one another phenylene, methylphenylene, methoxy-phenylene, chloro-phenylene, dichloro-phenylene or naphthalenediyl; X₁ to X₈ are hydrogen.

A preferred embodiment 4 concretizing any one of embodiments 1 to 3, wherein R₁ and R₂ are independently from one another —CH₂C₆H₄OCH₃ or —CH₂CH₂C₆H₅; R₃ and R₄ are independently of one another phenylene, 4-chloro-phenylene, naphthalenediyl or 4,5-dichloro-phenylene; X₁ to Xs are hydrogen.

A preferred embodiment 5 concretizing any one of embodiments 1 to 4, wherein R₁ is R₂ or wherein R₃ is R₄ or wherein R₁ is R₂ and R₃ is R₄, preferably wherein R₁ is R₂ and R₃ is R₄.

A preferred embodiment 6 concretizing any one of embodiments 1 to 5, wherein X is 4-methoxyphenyl and n is 1; R₃ and R₄ are phenylene; X₁ to X₈ are hydrogen.

A preferred embodiment 7 concretizing any one of embodiments 1 to 5, wherein X is 4-methoxyphenyl and n is 1; R₃ and R₄ are naphthalenediyl; X₁ to X₈ are hydrogen.

A preferred embodiment 8 concretizing any one of embodiments 1 to 5, wherein X is 4-methoxyphenyl and n is 1; R₃ and R₄ are 4-chloro-phenylene; X₁ to X₈ are hydrogen.

A preferred embodiment 9 concretizing any one of embodiments 1 to 5, wherein X is 4-methoxyphenyl and n is 1; R₃ and R₄ are 4,5-dichloro-phenylene; X₁ to X₈ are hydrogen.

A preferred embodiment 10 concretizing any one of embodiments 1 to 5, wherein X is phenyl and n is 2; R₃ and R₄ are phenylene; X₁ to X₈ are hydrogen.

A preferred embodiment 11 concretizing any one of embodiments 1 to 5, wherein X is phenyl and n is 2; R₃ and R₄ are naphthalenediyl; X₁ to X₈ are hydrogen.

A preferred embodiment 12 concretizing any one of embodiments 1 to 5, wherein X is phenyl and n is 2; R₃ and R₄ are 4-chloro-phenylene; X₁ to X₈ are hydrogen.

A preferred embodiment 13 concretizing any one of embodiments 1 to 12, exhibiting a color non-depending black value M_{Y} in the range of from 200 to 350, preferably in the range of from 220 to 330, more preferably in the range of from 230 to 300, more preferably in the range of from 242 to 280, and a color depending black value M_{C} in the range of from 200 to 350, preferably in the range of from 220 to 330, more preferably in the range of from 230 to 300, more preferably in the range of from 242 to 280, M_{Y} and M_{C} being determined according to DIN EN ISO 18314-3.

A preferred embodiment 14 concretizing any one of embodiments 1 to 13, being a black nearinfrared (NIR) neutral transparent pigment of neutral hue, wherein near-infrared represents a wavelength in the range of from 700 to 2500 nanometers, and wherein transparent represents a transparency in the near-infrared region having a transmission of >70%, preferably of 80% at 1000 nm.

A preferred embodiment 15 concretizing any one of embodiments 1 to 14, exhibiting a TSR value over a reflective substrate (TSR value>80%) of a value of >25%, preferably of a value of >33%.

A preferred embodiment 16 concretizing any one of embodiments 1 to 15, exhibiting a nearinfrared (NIR) reflectance over a reflective substrate (>90% reflectance) at 905 nm of a value of >65%, preferably of a value of >75%, over a reflective substrate (>70% reflectance) at 1550 nm of a value of >50%, preferably of a value of >60%.

A preferred embodiment 17 concretizing any one of embodiments 1 to 16, wherein the particle size is in the range of from 5 to 1000 nm, preferably in the range of from 10 to 500 nm, more preferably in the range of from 20 to 200 nm.

A preferred embodiment 18 concretizing any one of embodiments 1 to 17, wherein the solid solution comprises, preferably consists of, one crystal modification, more preferably comprises, more preferably consists of, one crystal modification in an amount of more than 80 weight-%, more preferably in an amount of more than 90 weight-%, based on the total weight of the solid solution.

A preferred embodiment 19 concretizing any one of embodiments 1 to 18, wherein in the solid solution, the weight ratio of the at least compound of formula (I) relative to the at least one compound according to formula (II) or to the at least one compound according to formula (III) or to the mixture of at least one compound according to formula (II) and at least one compound according to formula (III), weight((I)):weight((II)(II)), is in the range of from 60:40 to 99:1, preferably in the range of from 65:35 to 95:5, more preferably in the range of from 70:30 to 90:10, such as in the range of from 70:30 to 80:20 or in the range of from 75:25 to 85:15 or in the range o from 80:20 to 90:10.

A preferred embodiment 20 concretizing any one of embodiments 1 to 19, wherein from 80 to 100 weight-%, preferably from 85 to 100 weight-%, more preferably from 90 to 100 weight-%, more preferably from 95 to 100 weight-%, more preferably from 99 to 100 weight-%, more preferably from 99.5 to 100 weight-% of the solid solution consist of
(a) the at least one compound according to formula (I) and
(b) the at least one compound according to formula (II), or the at least one compound according to formula (III), or the mixture of the at least one compound according to formula (II) and the at least one compound according to formula (III).

A preferred embodiment 21 concretizing any one of embodiments 1 to 20, comprising
(a) one compound according to formula (I) and
(b) one compound according to formula (II), or one compound according to formula (III), or a mixture of one compound according to formula (II) and one compound according to formula (III).

A preferred embodiment 22 concretizing any embodiments 21, wherein from 80 to 100 weight %, preferably from 85 to 100 weight-%, more preferably from 90 to 100 weight-%, more preferably from 95 to 100 weight-%, more preferably from 99 to 100 weight-%, more preferably from 99.5 to 100 weight-% of the solid solution consist of
(a) one compound according to formula (I) and
(b) one compound according to formula (II), or one compound according to formula (III), or a mixture of one compound according to formula (II) and one compound according to formula (III).
According to an embodiment 23, the present invention relates to a process for producing a solid solution, comprising
   (i) providing a mixture comprising
      (a) at least one compound according to formula (I)

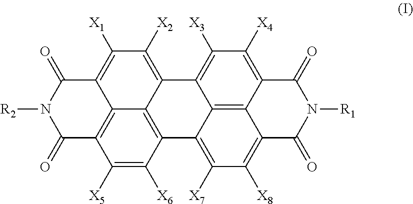

and
(b) at least one compound according to formula (II), or at least one compound according to formula (III), or a mixture of at least one compound according to formula (II) and at least one compound according to formula (III)

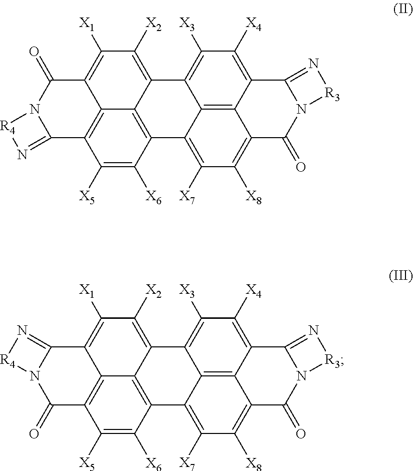

wherein R₁ and R₂ are independently of one another —(CH₂)ₙ—X, wherein X is hydrogen, methyl, a C₁-C₅ alkoxyl, hydroxy, phenyl, C₁-C₅ alkylphenyl, C₁-C₅ alkoxyphenyl, hydroxyphenyl, halogenated phenyl, pyridyl, C₁-C₅ alkylpyridyl, C₁-C₅ alkoxypyridyl, halogenated pyridyl, pyridylvinyl or naphthyl; wherein n is 0, 1, 2, 3, 4 or 5; R₃ and R₄ are independently of one another phenylene, C₁-C₅ alkylphenylene, C₁-C₅ alkoxyphenylene, hydroxyphenylene, halogenated phenylene, pyridinediyl, C₁-C₅ alkylpyridinediyl, C₁-C₅ alkoxypyridinediyl, halogenated pyridinediyl, anthraquinonediyl or naphthalenediyl, wherein the 2 nitrogen atoms bound to R₃ according to formula (II) and (III) form a 5-membered or a 6-membered heterocycle with 2 atoms of an aromatic ring of R₃; wherein the 2 nitrogen atoms bound to R₄ according to formula (II) and (III) form a 5-membered or a 6-membered heterocycle with 2 atoms of an aromatic ring of R₄; X₁ to X₈ are independently from one another hydrogen, C₁-C₅ alkyl, C₁-C₅ alkoxy, hydroxy, phenyl or halide;
(ii) subjecting the mixture provided according to (i) to mechanical treatment;
(iii) adding water to the mixture obtained from (ii);
(iv) subjecting the mixture obtained from (iii) to solid-liquid separation;
(v) washing the solids obtained from (iv) with at least one suitable washing agent;
(vi) drying the solids obtained from (v), obtaining the solid solution.

A preferred embodiment 24 concretizing embodiment 23, wherein providing a mixture according to (i) comprises adding at least one suitable acid or solvent to the mixture, wherein the at least one suitable acid is preferably one or more of polyphosphoric acid and sulfuric acid, wherein more preferably, the at least one suitable acid comprises, more preferably is sulfuric acid, and wherein the at least one solvent comprises, preferably is water.

A preferred embodiment 25 concretizing embodiment 23 or 24, wherein providing a mixture according to (i) is carried out at a temperature of the mixture in the range of from 30 to 120° C., preferably in the range of from 40 to 110° C., more preferably in the range of from 50 to 100° C.

A preferred embodiment 26 concretizing embodiment 23, wherein providing a mixture according to (i) is carried out at a temperature of the mixture in the range of from 30 to 80° C., preferably in the range of from 40 to 70° C., more preferably in the range of from 45 to 60° C., the process preferably further comprises adding at least one suitable base, solvent or sodium hydrosulfite to the mixture, wherein the at least one suitable base is preferably one or more of sodium hydroxide and potassium hydroxide, wherein more preferably, the at least one suitable base is sodium hydroxide, and wherein the at least one solvent comprises, preferably is water, more preferably wherein the process further comprises adding at least one suitable oxidant, wherein more preferably, the at least one suitable oxidant is one or more of oxygen or hydrogen peroxide.

A preferred embodiment 27 concretizing any one of embodiments 23 to 26, wherein the mechanical treatment according to (ii) comprises one or more kneading and milling, wherein kneading comprises coextrusion, salt kneading, single-shaft kneading and double-shaft kneading and wherein milling comprises wet milling, ball milling, bead milling, vibration milling, planetary milling and attritor milling.

A preferred embodiment 28 concretizing embodiment 27, wherein the mechanical treatment according to (ii) comprises, preferably is kneading, wherein said kneading is carried out at a temperature of the mixture in the range of from 40 to 120° C., preferably in the range of from 45 to 90° C., more preferably in the range of from 50 to 90° C., the process preferably further comprising, either directly before and/or during kneading, adding one or more suitable solvent and/or one or more of sodium chloride, sodium sulfate and anhydrous aluminium sulfate, preferably sodium chloride to the mixture to be kneaded, wherein more preferably the weight ratio of one or more of sodium chloride, sodium sulfate and anhydrous aluminium sulfate relative to the mixture provided according to (i), is in the range of from 20:1 to 1:1, preferably 15:1 to 2:1, more preferably 10:1 to 2:1, more preferably 8:1 to 2:1, more preferably 6:1 to 2:1, and more preferably 4:1 to 2:1, and wherein the at least one solvent is preferably one or more ethylene glycol, diethylene glycol, diacetone alcohol, dimethylformamide, glycerine, triethylene glycol, dipropylene glycol, ethylene glycol monobutyl ether, methyl ethyl ketone, cyclohexanone, dimethylacetamide, N-methylpyrrolidone, butyl acetate, glycerol triacetate, sulfolane, xylene, tetrahydrofuran, butanol, water and dimethyl sulfoxide, wherein more preferably, the at least one solvent comprises, more preferably is diethylene glycol, diacetone alcohol, dimethylformamide, xylene, butanol, water and glycerine.

A preferred embodiment 29 concretizing embodiment 27 or 28, wherein the mechanical treatment according to (ii) further comprises, either directly before and/or during kneading, adding at least one or more of a synergist comprising sulfonic and carboxylic acid derivatives of perylene, indanthrone, phthalocyanine and diketopyrrolopyrrole, preferably in an amount of 1 to 15 weight-%, more preferably 1 to 5 weight-%, based on the total weight of the kneaded mixture, and/or a natural or synthetic resin comprising esters and salts of abietic acid, hydrated or partially hydrogenated or dimerised rosin, preferably in an amount of 1 to 50 weight-%, more preferably 5 to 30 weight-%, based on the total weight of the kneaded mixture or polysorbate-type nonionic surfactant comprising an ester or a mixture of esters formed from fatty acids, like lauric or sebacic acid, and polyols, like sorbitan monolaureate or dibutylsebacate, preferably in an amount of 1 to 50 weight-%, more preferably 5 to 30 weight-%, based on the total weight of the kneaded mixture, to the mixture to be kneaded.

A preferred embodiment 30 concretizing any one of embodiments 27 to 29, wherein the mechanical treatment according to (ii) comprises, preferably is milling, wherein said milling is carried out at a temperature of the mixture in the range of from 40 to 120° C., preferably in the range of from 45 to 90° C., more preferably in the range of from 50 to 90° C., the process preferably further comprising, either directly before and/or during milling, adding one or more of sodium chloride, sodium sulfate and anhydrous aluminium sulfate, preferably sodium chloride to the mixture to be milled.

A preferred embodiment 31 concretizing embodiment 30, wherein the process further comprises, directly after milling, adding at least one suitable acid or solvent to the milled mixture under stirring at a temperature of the mixture in the range of from 40 to 200° C., preferably in the range of from 45 to 150° C., more preferably in the range of from 50 to 120° C., wherein the at least one suitable acid is preferably one or more of polyphosphoric acid and sulfuric acid, wherein more preferably, the at least one suitable acid comprises, more preferably is sulfuric acid, and wherein the at least one solvent is preferably one or more ethylene glycol, diethylene glycol, diacetone alcohol, dimethylformamide, glycerine, triethylene glycol, dipropylene glycol, ethylene glycol monobutyl ether, methyl ethyl ketone, cyclohexanone, dimethylacetamide, N-methylpyrrolidone, butyl acetate, glycerol triacetate, sulfolane, xylene, tetrahydrofuran, butanol, water and dimethyl sulfoxide, wherein more preferably, the at least one solvent comprises, more preferably is diethylene glycol, diacetone alcohol, dimethylformamide, xylene, butanol, water and glycerine.

A preferred embodiment 32 concretizing embodiment 30 or 31, wherein milling is carried out with steel balls, silicon/aluminum/zirconium oxide beads, glass beads, ceramic beads and agate balls, preferably having a diameter in the range from 0.1 to 5 cm, and wherein milling is wet milling and wherein wet milling is carried out in water or in a mixture of water and at least one suitable organic solvent, and optionally at least one suitable base, wherein more preferably, the at least one suitable solvent comprises, more preferably is methanol, ethanol, propanol, isopropanol butanol, pentanol, ethylene glycol, diethylene glycol, triethylene glycol and dipropylene glycol, and wherein more preferably, the at least one suitable base comprises, more preferably is, sodium hydroxide, potassium hydroxide, sodium hydroxide, lithium hydroxide and benzyl trimethylammonium hydroxide.

A preferred embodiment 33 concretizing any one of embodiments 30 to 32, wherein the mechanical treatment according to (ii) further comprises, either directly before and/or during milling, adding one or more of a synergist, preferably in an amount of 1 to 15 weight-%, more preferably 1 to 5 weight-%, based on the total weight of the milled mixture, and/or a natural or synthetic resin comprising esters and salts of abietic acid, hydrated or partially hydrogenated or dimerised rosin, preferably in an amount of 1 to 50 weight-%, more preferably 5 to 30 weight-%, based on the total weight of the milled mixture or polysorbate-type nonionic surfactant comprising an ester or a mixture of esters formed from fatty acids, like lauric or sebacic acid, and polyols, like sorbitan monolaureate or dibutylsebacate, preferably in an amount of 1 to 50 weight-%, more preferably 5 to 30 weight-%, based on the total weight of the milled mixture, to the mixture to be milled.

A preferred embodiment 34 concretizing any one of embodiments 30 to 33, wherein at least one or more of a synergist comprises sulfonic and carboxylic acid derivatives of perylene, indanthrone(PB 60), copper, aluminium or zinc phthalocyanine, quinacridone (PV 19, PR 202), dioxazine (PV 23, PV 37, PB 80) and diketopyrrolopyrrole (PR 254, PR 255).

A preferred embodiment 35 concretizing any one of embodiments 23 to 34, wherein the solidliquid separation according to (iv) comprises one or more of centrifugation and filtration, more preferably filtration.

A preferred embodiment 36 concretizing any one of embodiments 23 to 35, wherein the at least one suitable washing agent according to (v) comprises, more preferably is water, wherein the solids obtained from (iv) are preferably washed until the water obtained from washing exhibits a conductivity of at most 100 microSiemens/cm.

A preferred embodiment 37 concretizing any one of embodiments 23 to 36, wherein drying the solids obtained from (v) is carried out in a gas atmosphere, said gas atmosphere preferably being one or more of nitrogen, air, and lean air and preferably having a temperature in the range of from 50 to 150, more preferably from 50 to 95° C., more preferably 60 to 90° C., more preferably 70 to 85° C.

A preferred embodiment 38 concretizing any one of embodiments 23 to 37, wherein n, X, R₁, R₂, R₃, R₄, X₁ to X₈ and specific combinations thereof are as defined in any one of embodiments 2 to 12.

A preferred embodiment 39 concretizing any one of embodiments 23 to 38, wherein the solid solution is the solid solution according to any one of embodiments 1 to 22.

According to embodiment 40 the present invention relates to a solid solution, preferably a solid solution according to any one of embodiments 1 to 22, obtainable or obtained by a process according to any one of embodiments 23 to 39.

According to embodiment 41 the present invention relates to a solid solution according to any one of embodiments 1 to 22 or 40, comprised in one or more of a thermoplastic, elastomeric, crosslinked or inherently crosslinked polymer, preferably a polyolefin, polyamide, polyurethane, polyacrylate, polyacrylamide, polyvinyl alcohol, polycarbonate, polystyrene, polyester, polyacetal, a natural or synthetic rubber and a halogenated vinyl polymer in an amount from 0.01 weight-% to 70 weight-% based on the total weight of the polymer.

According to embodiment 42 the present invention relates to a solid solution according to any one of embodiments 1 to 22 or 40, comprised in one or more of a coating composition which is applied to the surface of the substrate, preferably a thermoplastic, elastomeric, crosslinked or inherently crosslinked polymer which is in the form of a film or coating applied to the surface of a substrate, or in the form of a fiber, sheet or other moulded or shaped article.

According to embodiment 43 the present invention relates to a solid solution according to any one of embodiments 1 to 22 or 40, comprised in one or more of a coating composition, a light detection and ranging (LiDAR) device, a near-infrared (NIR) non-absorbing component, a photovoltaic component, a heat management component, a thermal insulation component, a coloring paint, a printing ink, a recyclable plastic article, a biodegradable mulch, a toner, a chargegenerating material, a color filter, a LC display and a security print component.

According to embodiment 44 the present invention relates to a solid solution according to any one of embodiments 1 to 22 or 40 for use as a component in one or more of a coating composition, a light detection and ranging (LiDAR) device, a near-infrared (NIR) non-absorbing component, a photovoltaic component, a heat management component, a thermal insulation component, a coloring paint, a printing ink, a recyclable plastic article, a biodegradable mulch, a toner, a charge-generating material, a color filter, a LC display and a security print component.

According to embodiment 45 the present invention relates to the use of a solid solution according to any one of embodiments 1 to 22 or 40 as a component of one or more of a coating composition, a light detection and ranging (LiDAR) device, a near-infrared (NIR) non-absorbing component, a photovoltaic component, a heat management component, a thermal insulation component, a coloring paint, a printing ink, a recyclable plastic article, a biodegradable mulch, a toner, a charge-generating material, a color filter, a LC display and a security print component.

According to embodiment 46 the present invention relates to a coating composition and/or a light detection and/or a ranging (LiDAR) device and/or a near-infrared (NIR) non-absorbing component and/or a photovoltaic component and/or a heat management component and/or a thermal insulation component and/or a coloring paint and/or a printing ink and/or a recyclable plastic article and/or a biodegradable mulch and/or a toner and/or a charge-generating material and/or a color filter and/or a LC display and/or a security print component, comprising a solid solution according to any one of embodiments 1 to 22 or 40.

According to embodiment 47 the present invention relates to a multilayer coating comprising: a primer coating comprising a solid solution according to any one of embodiments 1 to 22 or 40 and a white pigment or a reflective pigment having a reflectance of >5 0% in the range of 700 to 2500 nm, pigment in a weight ratio of from 1:99 to 99:1, preferably from 1:95 to 95:1; a basecoat comprising a black, preferably comprising a solid solution a solid solution according to any one of embodiments 1 to 22 or 40, colour, metallic or interference pigment; and optionally a clear topcoat.

According to embodiment 48 the present invention relates to the use of a solid solution according to any one of embodiments 1 to 22 or 40 for producing one or more of a coating composition, a light detection and ranging (LiDAR) device, a near-infrared (NIR) non-absorbing component, a near-infrared (NIR) non-absorbing component, a photovoltaic component, a heat management component, a thermal insulation component, coloring paint, a printing ink, a plastic, a recyclable plastic article, a biodegradable mulch, a toner, a charge-generating material, a color filter, a LC display and a security print component.

According to embodiment 49 the present invention relates to a method for producing one or more of a coating composition, a light detection and ranging (LiDAR) device, a near-infrared (NIR) non-absorbing component, a photovoltaic component, a heat management component, a thermal insulation component, a coloring paint, a printing ink, a plastic, a recyclable plastic article, a biodegradable mulch, a toner, charge-generating material, a color filter, a LC display and a security print component, the method comprising providing and processing a solid solution according to any one of embodiments 1 to 22 or 40.

According to embodiment 50 the present invention relates to a method for identifying an item, wherein said item comprises a mark comprising an effective amount of a solid solution according to any one of embodiments 1 to 22 or 40, wherein said mark is recorded under irradiation by electromagnetic waves of wavelength from 700 to 2500 nm, and the mark's image is used for identifying the item.

According to embodiment 51 the present invention relates to a method for laser welding an article, wherein a solid solution according to any one of embodiments 1 to 22 or 40, is incorporated into a polymeric composition which is in contact with a surface of a meltable substrate containing a near infra-red absorbing material, then near infra-red radiation preferably from a laser of wavelength in the range from 700 to 2500 nm is passed through the layer containing the solid solution according to any one of embodiments 1 to 22 or 40 to the underlying substrate generating enough heat at the point of irradiation to melt together the two materials.

According to embodiment 52 the present invention relates to a method of identifying a recyclable plastic article comprising a solid solution according to any one of embodiments 1 to 22 or 40 with a laser signal of a wavelength in the range from 700 to 2500 nm.

According to embodiment 53 the present invention relates to the use of a solid solution according to any one of embodiments 1 to 22 or 40 as a near-infrared (NIR) transparent colorant which can replace near-infrared (NIR) absorbing black pigments in a coating or object to increase the signal to noise ratio in near-infrared (NIR) radiation detection.

According to embodiment 54 the present invention relates to the use of a solid solution according to any one of embodiments 1 to 22 or 40 for a LiDAR detection with a laser signal of a wavelength in the range from 700 to 2500 nm.

According to embodiment 55 the present invention relates to the use of a solid solution according to any one of embodiments 1 to 22 or 40 as a near-infrared (NIR) transparent black colorant in a near-infrared (NIR) non-absorbing component.

The present invention is further illustrated by the following Examples and Reference Examples.

### EXAMPLES

### Sample Preparations

Sample Preparations 1 to 10 were prepared using solid solutions obtained in Example 1 below. The term “pigment” used in the following herein under refers to the solid solution according to the present invention which were prepared according to Example 1 below.

### Sample Preparation 1: 20 Weight-% Pigment Millbase

A 20 weight-% pigment millbase was prepared by combining 20 weight-% of the pigment with 20 weight-% of a waterborne dispersant (Dispex® Ultra PX 4585 (50 weight-% dispersant and 50 weight-% water), an acrylic block copolymer supplied by BASF SE), 59.5 weight-% demineralised water and 0.5 weight-% antifoam additive (FoamStar® ST 2400 (100 weight-% defoamer) supplied by BASF SE) in a sealable container. Dispersion media (e.g. glass beads Ø 2 mm) were added to the container in the weight ratio 1:2 millbase components:beads and the container was sealed. The container was then loaded into a Skandex disperser (Skandex disperser is a well-known shaker disperser used extensively in the coatings industry. Similar designs are supplied by different companies of which LAU GmbH is one of the more popular suppliers) and the millbase components dispersed for 6 hrs. After dispersion, the beads were removed from the homogeneous liquid millbase by pouring the contents through a coarse filter. The resulting 20 weight-% pigment millbase was available for use in paint formulation.

### Sample Preparation 2: 15 Weight-% Carbon Black Millbase

A 15 weight-% carbon black millbase was prepared by combining 15 weight-% of Colour Black FW200 carbon black pigment (supplied by Orion Engineered Carbons) with 15 weight-% of a waterborne dispersant (Dispex® Ultra PX 4585 (50 weight-%) dispersant and 50 weight-% water), an acrylic block copolymer supplied by BASF SE), 69.6 parts demineralised water and 0.4 weight-% antifoam additive (FoamStar® ST 2400 (100 weight-%) supplied by BASF SE) in a sealable container. Dispersion media (e.g. glass beads 02 mm) were added to the container in the weight ratio 1:2 millbase components:beads and the container sealed. The container was then loaded into a Skandex disperser and the millbase components dispersed for 6 hrs. After dispersion, the beads were removed from the homogeneous liquid millbase by pouring the contents through a coarse filter. The resultant 15 weight-% carbon black pigment millbase was available for use in paint formulation.

Sample Preparation 3: 70 weight-% Pigment Titanium Dioxide Millbase A 70 weight-% pigment millbase was prepared by combining 70 weight-% of Kronos 2310 titanium dioxide pigment (supplied by Kronos Worldwide Inc.) with 6.5 weight-% of a waterborne dispersant (Dispex® Ultra PX 4575 (40 weight-% dispersant and 60 weight-% water), an acrylic block copolymer supplied by BASF SE), 23.1 weight-% demineralised water and 0.4 weight-% antifoam additive (FoamStar® ST 2400 (100 weight-%) supplied by BASF SE) in a sealable container. Dispersion media (e.g. glass beads Ø 2 mm) were added to the container in the weight ratio 1:2 millbase components:beads and the container sealed. The container was then loaded into a Skandex disperser and the millbase components dispersed for 1 hr. After dispersion, the beads were removed from the homogeneous liquid millbase by pouring the contents through a coarse filter. The resultant 70 weight-% pigment millbase was available for use in paint formulation.

TABLE 1
Summary of different millbases (the numbers in the table are given in
weight-%)

| | Carbon Black | Pigment | Pigment Titanium |
|---|---|---|---|
| Component | Millbase | Millbase | Dioxide Millbase |
| ¹Carbon Black Pigment | 15.0 | — | — |
| ²Pigment | — | 20.0 | — |
| ³Titanium Dioxide Pigment | — | — | 70.0 |
| ⁴Dispex ® Ultra PX 4585 | 15.0 | 20.0 | — |
| ⁵Dispex ® Ultra PX 4575 | — | — | 6.5 |
| Demineralised water | 69.6 | 59.5 | 23.1 |
| ⁶FoamStar ® ST 2400 | 0.4 | 0.5 | 0.4 |

¹Pigment Black 7 carbon black pigments are available commercially from various pigment companies e.g. Colour Black FW200, Orion Engineered Carbons
²Pigments according to Examples 1 to 2
³Pigment White 6 titanium dioxide pigments are available commercially from various pigment companies e.g. Kronos 2310, Kronos Worldwide Inc.
⁴Available commercially from BASF SE
⁵Available commercially from BASF SE
⁶Available commercially from BASF SE

### Sample Preparation 4: Waterborne Basecoat Let-Down Resin

A waterborne let-down resin system was prepared by combining 15 weight-% alkali swellable acrylic dispersion (Setaqua® 6802 (24 weight-% solid resin material, 76 weight-% solvents and neutralising base) supplied by Allnex Resins), 9 weight-% thermosetting waterborne acrylic emulsion (Setaqua® 6160 (45 weight-% solid resin material, 55 weight-% volatile solvents and neutralising base) supplied by Allnex Resins), 52 weight-% aliphatic polyester based polyurethane emulsion (Daotan® TW 6466/36WA (36 weight-% solid resin material, 64 weight-% solvents and neutralising base) supplied by Allnex resins) and 4.8 weight-% of a methylated monomeric melamine crosslinker (Cymel® 303LF (>98 weight-% solid resin material, <2 weight-% volatile solvents and formaldehyde) supplied by Allnex Resins). Demineralised water, neutralising amine (dimethylethanolamine) and co-solvent (butyl glycol) were also incorporated to adjust the solids, viscosity and pH parameters of the let-down resin as used by somebody skilled in the art of waterborne resin system preparation.

### Sample Preparation 5: Aluminium Base

7.60 weight-% Toyal TCR 3040 silver dollar, non-leafing aluminium paste (supplied by Toyo Aluminium) was wetted out with 2 weight-% Additol® XL250 pigment wetting agent (55 weight-% solid and 45 weight-% volatile components including solvents) supplied by Allnex Resins) and 11 weight-% hydrophilic solvents (n-butanol and butyl glycol). Once fully wetted out and homogeneous, 50 weight-% waterborne basecoat let-down resin (Sample Preparation 4) was added under stirring followed by 29.4 weight-% demineralised water.

### Sample Preparation 6: Pigment Masstone Basecoat (2.5 Weight-% Pigment)

12.5 weight-% of the 20 weight-% pigment millbase (Sample Preparation 1) were combined under stirring with 60 weight-% of the Waterborne Basecoat Let-down resin (Sample Preparation 4) and other co-solvent and application additives (e.g. wetting agent) known to those skilled in the art of waterborne coatings preparation. Viscosity and pH adjustment are achieved using a combination of demineralised water, neutralised Rheovis® AS 1130 (30 weight-% alkali swellable acrylic copolymer emulsion (ASE) in water, supplied BASF SE) and neutralising amine (dimethylethanolamine) to achieve a viscosity of 40-45 secs DIN4 flow cup and a pH in the range 8.0 to 8.5.

### Sample Preparation 7: Carbon Black Masstone Basecoat (2.5 Weight-% Pigment)

16.7 weight-% of the 15 weight-% Carbon Black millbase (Sample Preparation 2) were combined under stirring with 60 weight-% of the Waterborne Basecoat Let-down resin (Sample Preparation 4) and other co-solvent and application additives (e.g. wetting agent) known to those skilled in the art of waterborne coatings preparation. Viscosity and pH adjustment are achieved using a combination of demineralised water, neutralised Rheovis® AS 1130 (30 weight-% alkali swellable acrylic copolymer emulsion (ASE) in water, supplied BASF SE) and neutralising amine (dimethylethanolamine) to achieve a viscosity of 40-45 secs DIN4 flow cup and a pH in the range 8.0 to 8.5.

TABLE 2
Summary of different masstone basecoats (the numbers in the table are
given in weight-%)

| | Pigment | |
|---|---|---|
| | Masstone | Carbon Black |
| Component | Basecoat | Masstone Basecoat |
| Waterborne Basecoat Let-down resin | 60.0 | 60.0 |
| Carbon Black Millbase | — | 16.7 |
| Pigment Millbase | 12.5 | — |
| ¹Wetting agent solution | 1.3 | 1.3 |
| ²Organic solvents | 2.5 | 2.5 |
| Demineralised water | 13.7 | 12.9 |
| ³Rheology and pH adjustment | 10.0 | 6.6 |

¹Wetting agent solution comprising Surfynol ® 104 (100 weight-% defoamer, supplied by Evonik in butyl glycol
²Blend of alcohol and glycol ether solvents to achieve good film coalescence
³Viscosity and pH adjustment are achieved using a combination of demineralised water, neutralised Rheovis ® AS 1130 (30 weight-% alkali swellable acrylic copolymer emulsion (ASE) in water, supplied BASF SE) and a neutralising amine (dimethylethanolamine)
Solids content 23.3 weight-%
Pigment content 2.5 weight-%
Pigment:Binder weight ratio 1:8.3

### Sample Preparation 8: 10:90 (Weight Ratio) Pigment:Titanium Dioxide White Reduction

10.1 weight-% of the 20 weight-% pigment millbase (Preparation 1) and 25.8 weight-% pigment titanium dioxide millbase (Preparation 3) were combined under stirring with 50.7 weight-% of the Waterborne Basecoat Let-down resin (Sample Preparation 4) and other co-solvent and application additives (e.g. wetting agent) known to those skilled in the art of waterborne coatings preparation. Viscosity and pH adjustment are achieved using a combination of demineralised water, neutralised Rheovis® AS 1130 (30 weight-% alkali swellable acrylic copolymer emulsion (ASE) in water, supplied BASF) and neutralising amine (dimethylethanolamine) to achieve a viscosity of 40-45 secs DIN4 flow cup and a pH in the range 8.0 to 8.5.

TABLE 3
Summary of different white reductions (the numbers in the table are given
in weight-%)

| | 10:90 Pigment:White | 10:90 Carbon Black: |
|---|---|---|
| Component | Reduction | White Reduction |
| Waterborne Basecoat | 50.7 | 50.7 |
| Let-down resin | | |
| Carbon Black Millbase | — | 13.4 |
| Pigment Millbase | 10.1 | — |
| Titanium Dioxide Millbase | 25.8 | 25.8 |
| ¹Wetting agent solution | 0.9 | 0.9 |
| ²Organic solvents | 2.5 | 2.5 |
| Demineralised water | 5.0 | 1.7 |
| ³Rheology and pH adjustment | 5.0 | 5.0 |

¹Wetting agent solution comprising Surfynol ® 104 (100 weight-% defoamer, supplied by Evonik in butyl glycol
²Blend of alcohol and glycol ether solvents to achieve good film coalescence
³Viscosity and pH adjustment are achieved using a combination of demineralised water, neutralised Rheovis ® AS 1130 (30 weight-% alkali swellable acrylic copolymer emulsion (ASE) in water, supplied BASF SE) and a neutralising amine (dimethylethanolamine)
Solids content 38.2 weight-%
Pigment content 20.1 weight-% (10:90 Black:Titanium dioxide)
Pigment:Binder weight ratio 1:0.9

### Sample Preparation 9:50:50 (Weight Ratio) Pigment:Aluminium Reduction

28.3 weight-% of the Aluminium Base (Sample Preparation 5) were combined with 45.0 weight % Waterborne Basecoat Let-down Resin (Sample Preparation 4) under stirring. Demineralised water, neutralising amine and co-solvent were added to adjust the solids and pH of the mixture. 8.5 weight-% of the 20 weight-% pigment millbase were added under stirring. Flake orientation in the basecoat was controlled using a Laponite® RD (clay type rheology based additive, supplied by Byk-Chemie GmbH). Final spray viscosity and pH adjustment are achieved using a combination of demineralised water, neutralised Rheovis® AS 1130 (30 weight-% alkali swellable acrylic copolymer emulsion (ASE) in water, supplied BASF) and neutralising amine (dimethylethanolamine) to achieve a viscosity of 40-45 secs DIN4 flow cup and a pH in the range 8.0 to 8.5.

TABLE 4
Summary of different aluminium reductions (the numbers in the table
are given in weight-%)

| | 50:50 | 50:50 |
|---|---|---|
| | Pigment: | Carbon Black: |
| | Aluminium | Aluminium |
| Component | Reduction | Reduction |
| Waterborne Basecoat Let-down resin | 45.0 | 45.0 |
| Carbon Black Millbase | — | 11.3 |
| Pigment Millbase | 8.5 | — |
| Aluminium Base | 28.3 | 28.3 |
| ¹Surfactant solution | 0.9 | 0.9 |
| ²Flake orientation additive | 3.5 | 3.5 |
| Demineralised water | 5.8 | 3.0 |
| ³Rheology and pH adjustment | 8.0 | 8.0 |

¹Wetting agent solution comprising Surfynol ® 104 supplied by Evonik in butyl glycol
²Flake control additive comprising clay type additive e.g. Laponite ® RD supplied by BYK-Chemie GmbH, a low molecular weight polypropylene glycol e.g. Pluriol ® P900 supplied by BASF SE and demineralised water
³Viscosity and pH adjustment are achieved using a combination of demineralised water, neutralised Rheovis ® AS 1130 (alkali swellable acrylic copolymer emulsion (ASE) in water, supplied BASF SE) and a neutralising amine (dimethylethanolamine)
Solids content 23.7 weight-%
Pigment content 3.4 weight-% (50:50 weight-% Pigment:Aluminium flake)
Pigment:Binder weight ratio 1:5.7

### Sample Preparation 10: 0.2 Weight-% Pigment Masstone in a Polyvinyl Chloride (PVC) Film

A polyvinyl chloride (PVC) film of thickness of ˜0.3 mm is produced on a twin-roll mill at 150° C. containing 0.2 weight-% of the pigment in a full shade application.

PVC grade: SorVyl DB 2105 transparent from Polymer-Chemie DE. Two roll mill type Collin 150 (Collin Lab & Pilot Solutions) with total milling time: ca. 10 min.

### REFERENCE EXAMPLES: DETERMINATION METHODS

a) L*a*b*C*h Coloristic Determination

The term L* (lightness) used herein means the lightness in the L*a*b* color space (also referred to as CIELAB) specified by the Commission Internationale de l'Eclairage, wherein a* and b* are the chromaticity coordinates. The L* value is measured at an observation angle of 25°. According to the CIELAB system, L*=100 means the lightest value (white), L*=0 means the darkest value (black). Generally, a L* value refers to an opaque coating.

The term C* (chrome) used herein means the chroma in the L*C*h color space (also referred to as CIELAB) specified by the Commission Internationale de l'Eclairage, wherein L* is the same lightness as in the L*a*b* color space and h is the hue angle.

Solid colors (CIELAB color measurement) were measured using Datacolor 650 d8 integrating sphere spectrophotometer with D65 illuminant and 10° observer. Data handling via BASF ColorCare software.

Effect colors (CIELAB color measurement) were measured using BYK-mac 6 angle spectrophotometer (−15°, 15°, 25°, 45°, 75⁰ and 110°) with D65 illuminant and 10° observer. Data handling via BASF ColorCare software.

b) Near-Infrared (NIR) Reflectance Determination-Total Solar Reflectance (TSR) and Specified Near-Infrared (NIR) Wavelengths (905 nm and 1550 nm)

The term TSR used herein means Total Solar Reflectance and is a measurement of surface reflective capability of an object in the wavelength range 300-2500 nm.

Near-infrared (NIR) reflectance at 905 nm and 1550 nm are seen as being representative of near-infrared (NIR) wavelengths used in LiDAR based autonomous driving applications.

TSR and the specified NIR wavelengths were measured using an Agilent Cary 5000 UV-VisNIR Spectrophotometer. The TSR was measured according to ASTM Standard Method E 903-96 using the direct normal solar spectral irradiance from ASTM G159-98.

c) XRD

X-ray diffraction was determined with a multiple sample changer operating in Bragg-Brentano geometry and equipped with a Lynx-Eye detector. Bruker D8 Advance XDR 2 was used. Primary side: Cu-anode, divergence slit set to 0.1°, air-scatter-shield in place; Secondary side: Air scatter slit 8 mm with a 0.5 mm Ni-absorption filter, 4° sollers, Lynx-Eye detector set to an opening angle of 3°. The sample was filled into the sample holder and smoothed with a glass slide.

d) Masstone, Titanium Dioxide Reduction and Aluminium Reduction Test Panels

All basecoat samples were spray applied onto unprimed Q-panel aluminium test panels using an automatic HVLP spray gun (High Volume Low Pressure, e.g. SATA LP90), mounted on an Intec laboratory spray robot. The basecoat layer was dried for 15 min at 80° C. Effective Metal Temperature (EMT). The basecoat was applied to a layer thickness where opacity was achieved (typical dry film thicknesses: Masstone 15-20 microns; 10:90 weight-% Pigment:TiO₂ reduction 30-35 microns; 50:50 weight-% Pigment:Al reduction 15-20 microns). A typical one component acrylic melamine based clearcoat, which contains a combination of UV absorber (e.g. Tinuvin® 400 (100% hydroxyphenyltriazine UV absorber), supplied by BASF SE) and hindered amine light stabilizer (HALS) (e.g. Tinuvin® 123 (100 weight-%) supplied by BASF SE), was then spray applied over the dried basecoat layer. After a rest time at ambient temperature to allow for solvent evaporation, the panels were baked for 30 min at 140° C. EMT. A dry film thickness of 35-40 microns clearcoat was applied.

These basecoat panels were used for colorimetry and accelerated weathering testing.

e) Masstone Test Panels for UV-Vis-NIR Spectroscopy

The 2.5 weight-% masstone basecoat samples (Sample Preparation 6) were applied onto Leneta opacity chart form 2A using a 150 micron wire wound applicator bar mounted on a Zehntner ZAA2300 automatic film applicator. After a rest time at ambient temperature to allow for solvent evaporation, the panels were dried for 30 min at 80° C. A dry film thickness of 20-25 microns was applied. A typical one component acrylic melamine based clearcoat, which contains a combination of UV absorber (e.g. Tinuvin® 400 (100 weight-% hydroxyphenyltriazine UV absorber), supplied by BASF SE) and hindered amine light stabilizer (HALS) (e.g. Tinuvin® 123 (100 weight-%) supplied by BASF SE), was then applied using a 100 micron wire wound applicator bar mounted on a Zehntner ZAA2300 automatic film applicator over the dried basecoat layer. After a rest time at ambient temperature to allow for solvent evaporation, the panels were baked for 30 min at 140° C. EMT. A dry film thickness of 35-40 microns clearcoat was applied.

These masstone panels were also used for colorimetry

f) Masstone Test Panels for Black Value Determination

The 2.5 weight-% masstone basecoat samples (Sample Preparation 6) were spray applied onto washed and alcohol cleaned, glass test panels using an automatic HVLP spray gun e.g. SATA LP90, mounted on an Intec laboratory spray robot. After a rest time at ambient temperature to allow for solvent evaporation, the panels were baked for 30 min at 140° C. A dry film thickness of 15-20 microns was applied.

g) Black Values

Color depending M_{C} and color non-depending M_{Y} black values were determined according to DIN EN ISO 18314-3 using the following equations:
Black Value (color non-depending)

M_{Y}=100*log(100/Y)
Black Value (color depending)

M_{C}=100*(log(Xₙ/X)−log(Zₙ/Z)+log(Yₙ/Y))
Black value, M_{C}, describes higher black value if there is a blue shade and lower black value if the shade is brown.
Absolute Contribution of Hue

ΔM=M_{C}−M_{Y}=100*(log(Xₙ/X)−Log(Zₙ/Z))

Black values were determined using Datacolor DC45S 45/0 spectrophotometer with D65 illuminant and 10° observer. Data handling via BASF ColorCare software.

h) UV-Vis-NIR (Near-Infrared Reflectance) Data

UV-Vis-NIR (near-infrared reflectance) data have been obtained using a spectrophotometer that measures the reflection/transmission characteristics of a sample across the UV, visible and NIR parts of the electromagnetic spectrum. UV-Vis-NIR data has been determined using an Agilent Cary 5000.

i) Particle Size

The particle size has been determined using transmission electron microscopy (TEM). A very small amount of the sample powder is transferred from the tip of a microspatula to a glass slide. It is wetted with 5 drops of ethanol and rubbed between another glass slide in order to distribute the pigment homogeneously. A carbon coated TEM grid (SF 162) is flat-dipped on the coated slide. After short drying in air the sample is then examined in a Zeiss Libra 120 transmission electron microscope, which is equipped with an omega filter operated at 120 kV in elastic light field mode at various magnifications at representative positions.

j) Coloristic Measurement of 0.2 Weight-% Pigment Masstone in PVC Film

The colorimetric measurement of the 0.2 weight-% pigment masstone (Sample Preparation 10) and standard in a full shade application is carried out over white using the spectral method ISO 18314-1 (2015) with d/8°- or 8°/d geometry using a gloss trap. Test characteristics are measured according to ISO 11664-4 (2008; 18314-2 (2015)) for the light source D65 and 10° standard observer over a white substrate.

### Example 1 Preparation of the Solid Solution Starting from Compounds According to Formula (I) and Formula (II) and/or (III)

Compound 1 was synthesized according to Justus Liebigs Annalen der Chemie, 1984, 483.

Compound 2 was synthesized according to U.S. Pat. No. 4,450,273, Example 1.

Compounds 3 to 6 were synthesized according to US 2010/0184983 A1, Example 1.

Compounds 1 and 2 correspond to the compound of formula (I), as defined in Embodiment 1 or claim 1, feature a).

Compounds 3 to 6 correspond to the compound of formula (II) or the compound of formula (III) or a mixture of compound of formula (II) and compound of formula (III) according to the present invention, as defined in Embodiment 1 or claim 1, feature b).

TABLE 5
Compounds 1 to 6 used for the solid solutions in Example 1

| Compound | X | n | R₃ and R₄ | X₁ to X₈ |
|---|---|---|---|---|
| 1 | phenyl | 2 | — | H |
| 2 | 4-methoxyphenyl | 1 | — | H |
| 3 | — | — | phenylene | H |
| 4 | — | — | 4-chloro-phenylene | H |
| 5 | — | — | naphthalenediyl | H |
| 6 | — | — | 4,5-dichloro-phenylene | H |

### Example 1.1: Solid Solution Comprising Compound 2 and Compound 3

A kneading apparatus (Z-blade kneader) with a capacity of 1.0 litre was charged with 26.25 g of Compound 2 and 8.74 g of Compound 3. 210 g of sodium chloride and 80 g of diethyleneglycol (DEG) were added to the kneader and the rotary speed was set at 65 rpm. The walls of the apparatus were thermostated at 50° C. After 6 hours of kneading at 50° C., the kneading was stopped. To the kneading mass 1500 g water was added. The mixture was filtered off and washed until the conductivity of the filtrate was below 100 pS/cm. The wet press-cake was dried in an oven at 60° C. for 48 h. The yield of the obtained solid solution was 31.70 g and comprised 75 weight-% Compound 2 and 25 weight-% Compound 3. The obtained solid solution was pulverized in a mill to obtain a black powder.

### Example 1.2: Solid Solution Comprising Compound 2 and Compound 3

A kneading apparatus (Z-blade kneader) with a capacity of 1.1 litre was charged with 41.6 g. Compound 2 and 10.4 g Compound 3. 208 g of sodium chloride and 58 g of diacetone alcohol (DAA) were added to the kneader and the rotary speed was set at 100 rpm. The walls of the apparatus were thermostated at 60° C. After 8 hours of kneading at 60° C., the kneading was stopped. To the kneading mass 1500 g water was added. The mixture was filtered off and washed until the conductivity of the filtrate was below 100 μS/cm. The wet presscake was dried in an oven at 80° C. for 24 h. The yield of the obtained solid solution was 48.9 g and comprised 80 weight-% Compound 2 and 20 weight-% Compound 3. The solid solution was pulverized in a mill to obtain a black powder.

### Example 1.3: Solid Solution Comprising Compound 2 and Compound 3

A kneading apparatus (Z-blade kneader) with a capacity of 1.1 litre was charged with 37.4 g. Compound 2, 9.4 g Compound 3 and 5.2 g partially hydrogenated rosin e.g. Staybelite Resin E supplied by Eastman Chemical Company. 208 g of sodium chloride and 58 g of diacetone alcohol (DAA) were added to the kneader. The walls of the apparatus were thermostated at 60° C. After 8 hours of kneading at 60° C., the kneading was stopped. To the kneading mass 1500 g water was added. The mixture was filtered off and washed until the conductivity of the filtrate was below 100 μS/cm. The wet presscake was dried in an oven at 80° C. for 24 h. The yield of the obtained solid solution was 48.9 g and comprised 72 weight-% Compound 2, 18 weight-% Compound 3 and 10 weight-% Staybelite Resin E. The solid solution was pulverized in a mill to obtain a black powder.

### Example 1.4: Solid Solution Comprising Compound 2 and Compound 3

A kneading apparatus (Z-blade kneader) with a capacity of 1.0 litre was charged with 26.25 g of Compound 2 and 8.74 g of Compound 3. 210 g of sodium chloride and 80 g of diethylenglycol (DEG) were added to the kneader. The walls of the apparatus were thermostated at 50° C. After 16 hours of kneading at 50° C., the kneading was stopped. To the kneading mass 1500 g water was added. The mixture was filtered off and washed until the conductivity of the filtrate was below 100 μS/cm. The wet press-cake was dried in an oven at 60° C. for 48 h. The yield of the obtained solid solution was 31.70 g and comprised 75 weight-% Compound 2 and 25 weight-% Compound 3. The obtained solid solution was pulverized in a mill to obtain a black powder.

### Example 1.5: Solid Solution Comprising Compound 2 and Compound 4

A kneading apparatus (Z-blade kneader) with a capacity of 1.1 litre was charged with 20.8 g. of Compound 2 and 5.2 g of Compound 4. 208 g of sodium chloride and 58 g of diacetone alcohol (DAA) were added to the kneader. The walls of the apparatus were thermostated at 65° C. After 12 hours of kneading at 65° C., the kneading was stopped. To the kneading mass 1500 g water was added. The mixture was filtered off and washed until the conductivity of the filtrate was below 100 μS/cm. The wet presscake was dried in an oven at 80° C. for 24 h. The yield of the obtained solid solution was 48.9 g and comprised 80 weight-% Compound 2 and 20 weight-% Compound 4. The solid solution was pulverized in a mill to obtain a black powder.

### Example 1.6: Solid Solution Comprising Compound 2 and Compound 3

A mixture of 8 g of Compound 2 and 2 g of Compound 3 were ground with 40 g of sodium chloride and 0.4 g of Lorol in a vibration mill charged with 1.5 kg of steel balls (diameter: 2.5 cm) for 48 h at 70° C. After 48 h at 70° C., the milling was stopped and the mixture was taken out of the mill. To the mixture 1500 g water was added and stirred for 1 h. Then, the mixture was filtered off and washed until the conductivity of the filtrate was below 100 μS/cm. The wet presscake was dried in an oven at 80° C. for 24 h. The yield of the obtained solid solution was 9.5 g and comprised 80 weight-% Compound 2 and 20 weight-% Compound 3. The obtained solid solution was pulverized in a mill to obtain a black powder.

### Example 1.7: Solid Solution Comprising Compound 2 and Compound 3

A mixture of 80 g of Compound 2 and 20 g of Compound 3 were ground in a 900 mL steel chamber, charged with 1.5 kg of steel balls (diameter: 2.5 cm) at 50° C. for 50 h. After removing the steel balls, the ground material 40 g. was added to 400 g of 75% sulfuric acid in a 500 mL round-bottom flask and stirred at 70° C. for 16 h at 350 rpm. Subsequently, the mixture was precipitated in 1500 mL of water while stirring for 30 min. The obtained solid solution was filtered off and dried and comprised 80 weight-% compound 2 and 20 weight-% Compound 3.

### Example 1.8: Solid Solution Comprising Compound 2 and Compound 3

A kneading apparatus (Z-blade kneader) with a capacity of 1.1 litre was charged with 22.2 g. of Compound 2 and 5.5 g of Compound 3. 222 g of sodium chloride and 43 g of diacetone alcohol (DAA) were added to the kneader. The walls of the apparatus were thermostated at 65° C. After 15 hours of kneading at 65° C., the kneading was stopped. To the kneading mass 1500 g water was added. The mixture was filtered off and washed until the conductivity of the filtrate was below 100 μS/cm. The wet presscake was dried in an oven at 80° C. for 24 h. The yield of the obtained solid solution was 26.5 g and comprised 80 weight-% Compound 2 and 20 weight-% Compound 3. The solid solution was pulverized in a mill to obtain a black powder.

### Example 1.9: Solid Solution Comprising Compound 2 and Compound 3

A kneading apparatus (Z-blade kneader) with a capacity of 1.1 litre was charged with 27.2 g. of Compound 2, 6.8 g of Compound 3. 215 g of sodium chloride, IBMS (indathrone blue sulfonic acid) 1.79 g and 58 g of diacetone alcohol (DAA) were added to the kneader. The walls of the apparatus were thermostated at 60° C. After 20 hours of kneading at 60° C., the kneading was stopped. To the kneading mass 1500 g water was added. The mixture was filtered off and washed until the conductivity of the filtrate was below 100 μS/cm. The wet presscake was dried in an oven at 80° C. for 24 h. The yield of the obtained solid solution was 35 g and comprised 80 weight-% Compound 2 and 20 weight-% Compound 3. The solid solution was pulverized in a mill to obtain a black powder.

### Example 1.10: Solid Solution Comprising Compound 2 and Compound 3

A kneading apparatus (Z-blade kneader) with a capacity of 3.5 litre was charged with 102.9 g Compound 2, 25.7 g Compound 3 and 14.3 g partially hydrogenated rosin e.g. Staybelite Resin E supplied by Eastman Chemical Company. 857 g of sodium chloride and 193 g of diacetone alcohol (DAA) were added to the kneader. The walls of the apparatus were thermostated at 90° C. After 12 hours of kneading at 90° C., the kneading was stopped. To the kneading mass 10 L water was added. The mixture was filtered off and washed until the conductivity of the filtrate was below 100 μS/cm. The wet presscake was dried in an oven at 80° C. for 24 h. The yield of the obtained solid solution was 127 g and comprised 72 weight-% Compound 2, 18 weight-% Compound 3 and 10 weight-% Staybelite Resin E. The solid solution was pulverized in a mill to obtain a black powder.

### Example 1.11: Solid Solution Comprising Compound 2 and Compound 6

A kneading apparatus (Z-blade kneader) with a capacity of 1.1 litre was charged with 23.1 g of Compound 2 and 5.8 g of Compound 6. 231 g of sodium chloride and 56 g of diacetone alcohol (DAA) were added to the kneader. The walls of the apparatus were thermostated at 65° C. After 12 hours of kneading at 65° C., the kneading was stopped. To the kneading mass 1500 g water was added. The mixture was filtered off and washed until the conductivity of the filtrate was below 100 μS/cm. The wet presscake was dried in an oven at 80° C. for 24 h. The yield of the obtained solid solution was 26.8 g and comprised 80 weight-% Compound 2 and 20 weight-% Compound 6. The solid solution was pulverized in a mill to obtain a black powder.

### Example 1.12 Solid Solution Comprising Compound 2 and Compound 5

A kneading apparatus (Z-blade kneader) with a capacity of 1.1 litre was charged with 29.7 g of Compound 2 and 7.4 g of Compound 5. 223 g of sodium chloride and 55 g of diacetone alcohol (DAA) were added to the kneader. The walls of the apparatus were thermostated at 90° C. After 8 hours of kneading at 90° C., the kneading was stopped. To the kneading mass 1600 g water was added. The mixture was filtered off and washed until the conductivity of the filtrate was below 100 μS/cm. The wet presscake was dried in an oven at 80° C. for 24 h. The yield of the obtained solid solution was 35.7 g and comprised 80 weight-% Compound 2 and 20 weight-% Compound 5. The solid solution was pulverized in a mill to obtain a black powder.

### COMPARATIVE EXAMPLES

Comparative Example 1 represents the single Compound 1 (Spectrasense™ Black S 0084 supplied by BASF Colors and Effects, formally known as Paliogen® Black S 0084). A comparative millbase containing Compound 1 only was prepared according to Sample Preparation 1. A comparative 2.5 weight-% Pigment Masstone containing Compound 1 only was prepared according to Sample Preparation 6. A comparative 10:90 (weight ratio) Compound 1:Titanium Dioxide Reduction prepared according to Sample Preparation 8. A comparative 50:50 (weight ratio) Compound 1:Aluminium Reduction was prepared according to Sample Preparation 9.

Comparative Example 2 represents the single Compound 2 (Spectrasense™ Black L 0086 supplied by BASF Colors and Effects, formally known as Paliogen® Black L 0086). A comparative millbase containing Compound 2 only was prepared according to Sample Preparation 1. A comparative 2.5 weight-% Pigment Masstone containing Compound 2 only was prepared according to Sample Preparation 6. A comparative 10:90 (weight ratio) Compound 2:Titanium Dioxide Reduction prepared according to Sample Preparation 8. A comparative 50:50 (weight ratio) Compound 2:Aluminium Reduction was prepared according to Sample Preparation 9.

Comparative Example 3 represents the single Compound 3 (Spectrasense™ Black K 0087 supplied by BASF Colors and Effects, formally known as Lumogen® Black K 0087). A comparative millbase containing Compound 3 only was prepared according to Sample Preparation 1. A comparative 2.5 weight-% Pigment Masstone containing Compound 3 only was prepared according to Sample Preparation 6. A comparative 10:90 (weight ratio) Compound 3:Titanium Dioxide Reduction prepared according to Sample Preparation 8. A comparative 50:50 (weight ratio) Compound 3:Aluminium Reduction was prepared according to Sample Preparation 9.

Comparative Example 4 corresponds to a physical mixture of 80 weight-% of Compound 2 (Spectrasense™ Black L 0086 supplied by BASF Colors and Effects, formally known as Paliogen® Black L 0086) and 20 weight-% of Compound 3 (Spectrasense™ Black K 0087 supplied by BASF Colors and Effects, formally known as Lumogen® Black K 0087), which do not form a solid solution. A comparative millbase containing a mixture of Compound 2 and Compound 3 was prepared according to Sample Preparation 1. A comparative 2.5 weight-% Pigment Masstone containing a mixture of Compound 2 and Compound 3 was prepared according to Sample Preparation 6. A comparative 10:90 (weight ratio) mixture of Compound 2 and Compound 3:Titanium Dioxide Reduction was prepared according to Sample Preparation 8. A comparative 50:50 (weight ratio) mixture of Compound 2 and Compound 3:Aluminium Reduction was prepared according to Sample Preparation 9.

Comparative Example 5 represents carbon black (Pigment Black 7). A comparative millbase containing carbon black (Pigment Black 7) only was prepared according to Sample Preparation 2. A comparative 2.5 weight-% Pigment Masstone containing carbon black (Pigment Black 7) only was prepared according to Sample Preparation 7.

TABLE 6
CIELAB panel data of a 2.5 weight-% Pigment Masstone prepared
according to Sample Preparation 6 over white

| Colour Position | | | | | |
|---|---|---|---|---|---|
| [SPEX 0.00 d8, over White] | h | C* | L* | a* | b* |
| Comparative Example 1 | 66.2 | 5.0 | 6.0 | 2.0 | 4.5 |
| Comparative Example 2 | 128.0 | 1.6 | 5.8 | −1.0 | 1.2 |
| Comparative Example 3 | 73.7 | 6.4 | 7.8 | 1.8 | 6.1 |
| Comparative Example 4 | 93.8 | 2.8 | 5.8 | −0.2 | 2.8 |
| Example 1.1 | 64.7 | 1.8 | 6.1 | 0.8 | 1.6 |
| Example 1.2 | 55.5 | 0.8 | 7.7 | 0.4 | 0.6 |
| Example 1.6 | 53.6 | 3.6 | 5.4 | 2.2 | 2.9 |
| Example 1.7 | 86.6 | 2.1 | 7.6 | 0.1 | 2.1 |

TABLE 7
CIELAB panel data (M_{C} color depending black value) of a 2.5 weight-%
Pigment Masstone prepared according to Sample Preparation 6 on glass

| Black Value [45/0, on Glass] | M_{C} |
|---|---|
| Comparative Example 2 | 241 |
| Comparative Example 3 | 199 |
| Comparative Example 4 | 225 |
| Example 1.1 | 243 |
| Example 1.2 | 250 |
| Example 1.3 | 248 |
| Example 1.4 | 255 |

From the above, by careful consideration of the processing conditions and the composition of the components used, solid solution pigments can be prepared. The inventive solid solution pigments can be seen to display highly desirable neutral black (masstone) coloristic and M_{C} properties, characterized by low a* and b* values and high M_{C} color depending black values compared to existing, available, single component, black perylene pigments of Comparative Examples.

TABLE 8
CIELAB panel data of a 10:90 weight-% Pigment:Titanium Dioxide
Reduction prepared according to Sample Preparation 8

| Colour Position [SPIN 0.04 d8] | | | | | |
|---|---|---|---|---|---|
| Strength Adjusted | h | C* | L* | a* | b* |
| Comparative Example 1 | 212.8 | 10.7 | 53.3 | −9.0 | −5.8 |
| Comparative Example 2 | 207.3 | 6.9 | 51.4 | −6.1 | −3.1 |
| Comparative Example 3 | 294.5 | 22.0 | 52.2 | 9.1 | −20.0 |
| Comparative Example 4 | 259.7 | 8.4 | 51.1 | −1.5 | −8.2 |
| Example 1.2 | 260.7 | 8.5 | 51.1 | −1.4 | −8.4 |
| Example 1.3 | 258.2 | 8.3 | 51.2 | −1.7 | −8.1 |
| Example 1.4 | 260.7 | 9.0 | 51.3 | −1.5 | −8.9 |
| Example 1.5 | 255.2 | 8.4 | 51.4 | −2.1 | −8.1 |
| Example 1.7 | 258.7 | 8.5 | 51.2 | −1.7 | −8.3 |

From the above, by careful consideration of the processing conditions and the composition of the components used, solid solution pigments can be prepared. The individual pigments can be seen to display highly desirable neutral grey (reduction) coloristic properties, characterized by very low a* and b* values compared to existing, available, single component, black perylene pigments of Comparative Examples.

TABLE 9
CIELAB panel data of a 50:50 weight-% Pigment:Aluminium Reduction
prepared according to Sample Preparation 9

| Colour Position [SPEX 0.00 −15°] | h | C* | L* | a* | b* |
|---|---|---|---|---|---|
| Comparative Example 1 | 163.5 | 17.9 | 84.7 | −17.2 | 5.1 |
| Comparative Example 2 | 124.0 | 16.6 | 101.0 | −8.9 | 13.2 |
| Comparative Example 3 | 308.9 | 41.8 | 69.2 | 26.3 | −32.6 |
| Comparative Example 4 | 55.6 | 1.2 | 89.3 | 0.7 | 1.0 |
| Example 1.2 | 29.9 | 0.7 | 89.0 | 0.6 | 0.4 |
| Example 1.3 | 61.6 | 0.8 | 87.0 | 0.4 | 0.7 |
| Example 1.4 | 335.8 | 1.5 | 88.9 | 1.3 | −0.6 |
| Example 1.5 | 118.8 | 1.5 | 84.3 | −0.7 | 1.3 |
| Example 1.7 | 357.1 | 0.6 | 87.2 | 0.6 | 0.0 |
| Colour Position [SPEX 0.00 110°] | h | C* | L* | a* | b* |
| Comparative Example 1 | 70.1 | 7.5 | 12.0 | 2.5 | 7.0 |
| Comparative Example 2 | 106.4 | 4.3 | 11.7 | −1.2 | 4.1 |
| Comparative Example 3 | 2.7 | 4.8 | 10.7 | 4.8 | 0.2 |
| Comparative Example 4 | 87.7 | 3.1 | 11.2 | −1.2 | 4.1 |
| Example 1.2 | 58.7 | 1.0 | 8.6 | 0.5 | 0.8 |
| Example 1.3 | 69.0 | 1.3 | 8.8 | 0.5 | 1.2 |
| Example 1.4 | 84.7 | 1.6 | 8.3 | 0.2 | 1.6 |
| Example 1.5 | 96.5 | 1.2 | 8.2 | −0.1 | 1.2 |
| Example 1.7 | 91.3 | 2.4 | 8.7 | −0.1 | 2.4 |

From the above, by careful consideration of the processing conditions and the composition of the components used, solid solution pigments can be prepared. The individual pigments can be seen to display highly desirable neutral grey (reduction) coloristic properties, characterized by very low a* and b* values compared to existing, available, single component, perylene black pigments.

Examples 1.2, 1.3, 1.4 and 1.7 (based on Compound 2 and Compound 3, 80:20 ratio) and Example 1.5 (based on Compound 2 and Compound 4, 80:20 ratio) prepared using appropriate processing methods, display very neutral black/grey coloristics from a single solid solution pigment.

The solid solution pigments described, when dispersed into a binder system e.g. for use in a coating, will behave as a single pigment providing predictable neutral coloristics at all concentrations, based on the weight content of the pigment in the formulation. Alternatively, a pigment blend such as Comparative Example 4 can be used and a neutral black/grey coloristic obtained. However, it be seen that the color depending black value M_{C} of the Comparative Example 4 is inferior compared to the solid solution pigment examples 1.1 to 1.4 (see Table 6). In addition, as two (or more) pigments are necessary for Comparative Examples 1 to 4 to achieve the required neutral coloristics, the coloristic obtained from the dispersed mixed pigments can vary significantly depending on the dispersion conditions used and the required tint level in the target color. In order to achieve the required coloristic at all concentrations when using a physical mixture of two (or more) pigments, generally the ratios of the blended components will need to be adjusted to achieve the same neutral coloristic.

TABLE 10
Near-infrared (NIR) reflectance data over a white reflective substrate
(>90% reflectance) at 905 nm and over a white reflective substrate
(>70% reflectance) at 1550 nm

| | 905 nm % | 1550 nm % |
|---|---|---|
| Examples | Over White | Over White |
| Comparative Example 1 | 85.2 | 71.4 |
| Comparative Example 2 | 87.0 | 72.3 |
| Comparative Example 3 | 70.9 | 70.5 |
| Comparative Example 4 | 83.2 | 70.5 |
| Comparative Example 5 | 4.2 | 4.1 |
| Example 1.2 | 81.1 | 71.5 |
| Example 1.3 | 85.9 | 69.9 |
| Example 1.4 | 84.3 | 70.3 |
| Example 1.5 | 78.8 | 69.7 |
| Example 1.7 | 88.6 | 71.0 |

A coating containing a conventional carbon black (Pigment Black 7) will strongly absorb at all wavelengths across the visible and NIR wavelength regions (400-2500 nm). This can be observed for Comparative Example 5 where low NIR reflectance values at 905 nm and 1550 nm are observed.

From the above, by careful consideration of the processing conditions and the composition of the components used, solid solution pigments can be prepared. The individual inventive solid solution pigments can be seen to display highly desirable NIR non-absorbing properties, characterized by very high NIR reflectance values compared to existing, available, single component, black perylene pigments of the Comparative Examples.

TABLE 11
Total solar reflectance (TSR) over a white reflective substrate
(TSR value >80%)

| | TSR % |
|---|---|
| Examples | Over White |
| Comparative Example 1 | 44.5 |
| Comparative Example 2 | 40.9 |
| Comparative Example 3 | 32.4 |
| Comparative Example 4 | 36.4 |
| Comparative Example 5 | 4.2 |
| Example 1.2 | 36.2 |
| Example 1.3 | 37.1 |
| Example 1.4 | 36.6 |
| Example 1.5 | 34.5 |
| Example 1.7 | 38.8 |

A coating containing a conventional carbon black (Pigment Black 7) will strongly absorb at all wavelengths across the visible and NIR wavelength regions (400-2500 nm). This can be observed for Comparative Example 5 where a low TSR value is observed.

From the above, by careful consideration of the processing conditions and the composition of the components used, solid solution pigments can be prepared. The individual inventive solid solution pigments can be seen to display highly desirable NIR non-absorbing properties, characterized by TSR values compared to existing, available, single component, black perylene pigments of Comparative Examples.

The total solar reflectance is more strongly affected by the visible and short wavelength NIR radiation than by longer wavelength NIR radiation. In other words, small differences in the absorption behavior for the inventive solid solution in the 700 to 1000 nm will have a strong influence on the TSR value.

The higher the wavelength at which the inventive solid solution pigment becomes transparent (increased reflectance over white) the lower the TSR value. For Example 1.2, in order to improve the coloristics in the visible region, the absorption band extends slightly into the NIR and as a result it only starts to become transparent at ca. 780 nm. Example 1.2 is therefore NIR non-absorbing across a region ca. 100 nm narrower than for Comparative Example 1, resulting in an inferior TSR value, even though the coloristics in the visible region are significantly better. Accordingly, the inventive solid solution pigments provide good coloristics combined with good TSR performance, which makes the inventive solid solution pigments good tools for the control of NIR absorption.

As can be taken from Tables 10 and 11, for all examples based on inventive solid solution, the NIR reflectivity and TSR values are significantly improved when compared with carbon black as illustrated by Comparative Example 5.

TABLE 12
CIELAB data of a 0.2 weight-% pigment masstone prepared according
to Sample Preparation 10

| Colour Position [SPEX 0.00 d8, over White] | h | C* | L* | a* | b* |
|---|---|---|---|---|---|
| Comparative Example 2 | 236.6 | 1.8 | 18.9 | −1.0 | −1.5 |
| Comparative Example 3 | 295.8 | 0.3 | 19.2 | 0.1 | −0.3 |
| Example 1.10 | 254.7 | 2.0 | 18.9 | −0.5 | −2.0 |

The inventive solid solution pigments can be seen to display highly desirable neutral to bluish black (masstone) coloristic properties, characterized by L*, a* and b* values compared to existing, available, single component, black perylene pigments of Comparative Examples 2 and 3.

### BRIEF DESCRIPTION OF THE FIGURES

FIG. 1 shows a XRD spectrum of Example 1.1

FIG. 2 shows a XRD spectrum of Example 1.2

FIG. 3 shows a XRD spectrum of Example 1.5

FIG. 4 shows a XRD spectrum of Example 1.6

FIG. 5 shows a XRD spectrum of Example 1.7

FIG. 6 shows a XRD spectrum of Comparative Example 1

FIG. 7 shows a XRD spectrum of Comparative Example 2

FIG. 8 shows a XRD spectrum of Comparative Example 3

FIG. 9 shows a XRD spectrum of Comparative Example 4

FIG. 10 shows a XRD spectrum of Comparative Example 5

FIG. 11 shows a Pigment masstone basecoat (2.5% pigment of Example 1) prepared according to Sample Preparation 6

FIG. 12 shows a 10:90 weight-% Pigment (Example 1):Titanium Dioxide White Reduction prepared according to Sample Preparation 8

FIG. 13a shows all angles of a CIELAB panel of a 50:50 weight-% Pigment (Example 1):Aluminium Reduction prepared according to Sample Preparation 9

FIG. 13b shows zoom in all angles of a CIELAB panel of a 50:50 weight-% Pigment:Aluminium Reduction prepared according to Sample Preparation 9

FIG. 14 shows Vis-NIR reflectance

FIG. 15 shows a XRD spectrum of Example 1.11

FIG. 16 shows a XRD spectrum of Example 1.12

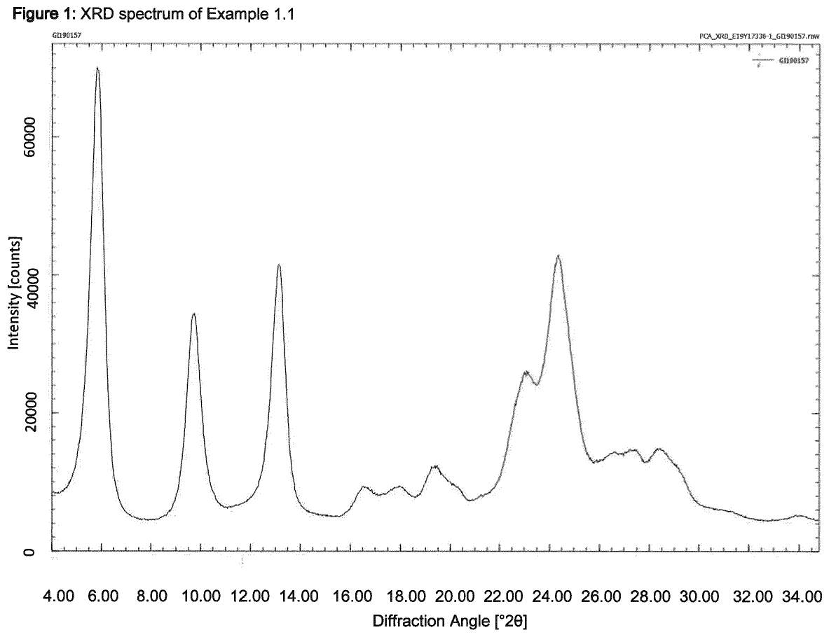

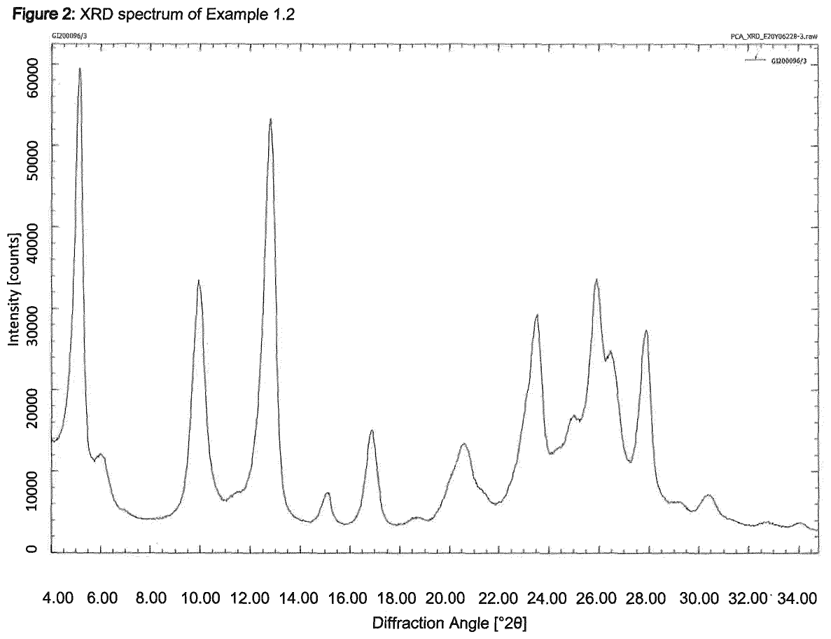

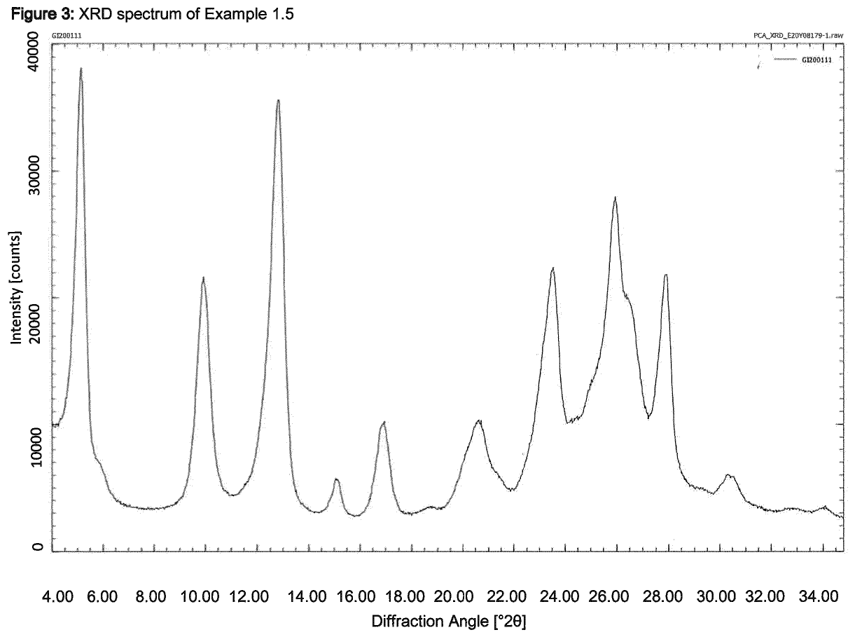

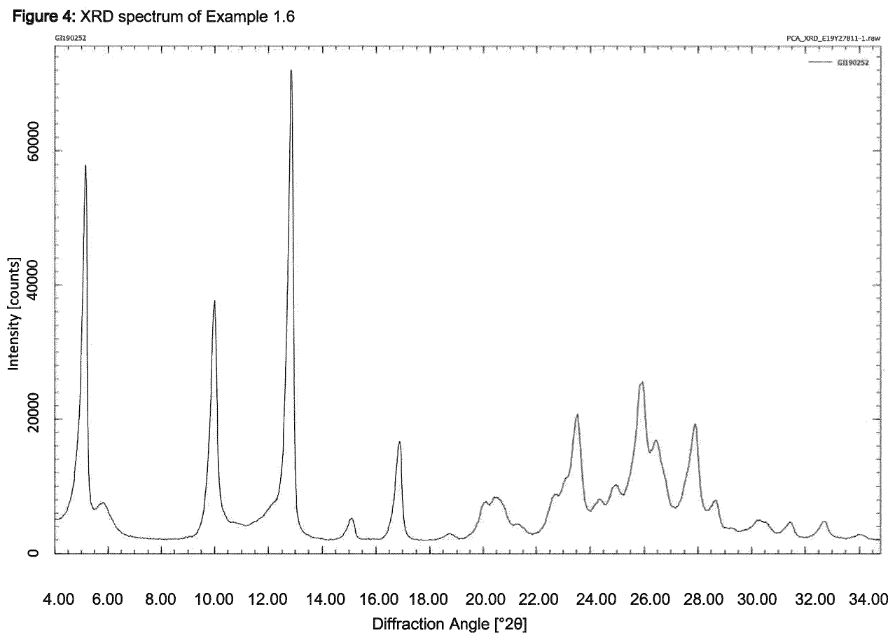

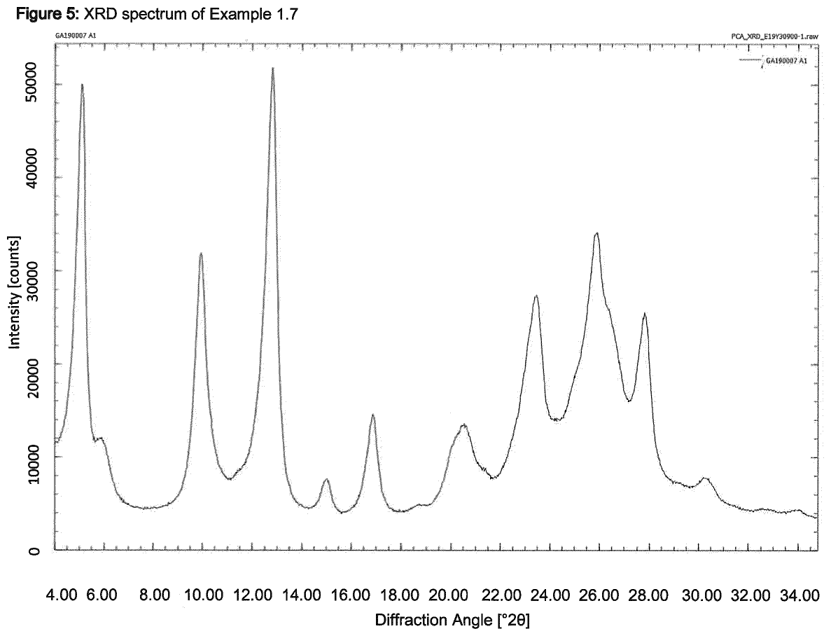

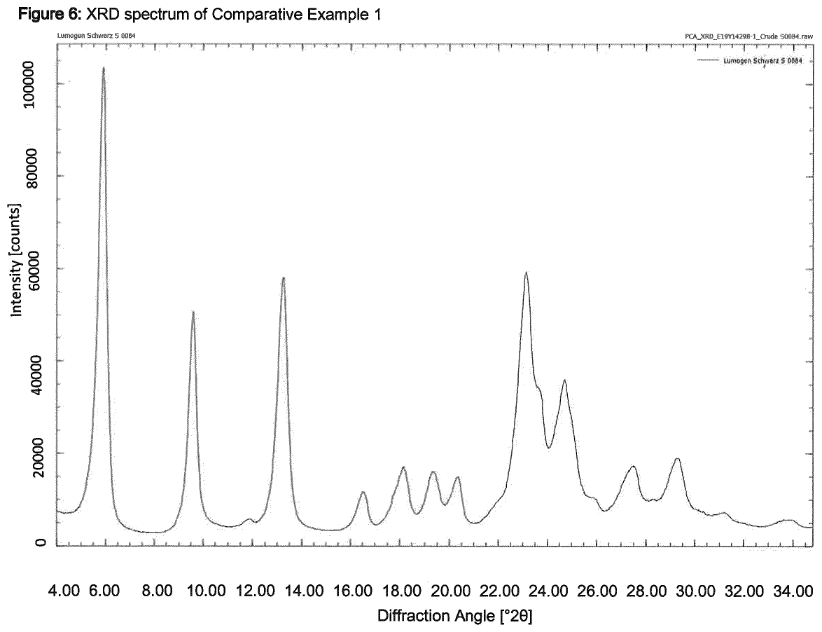

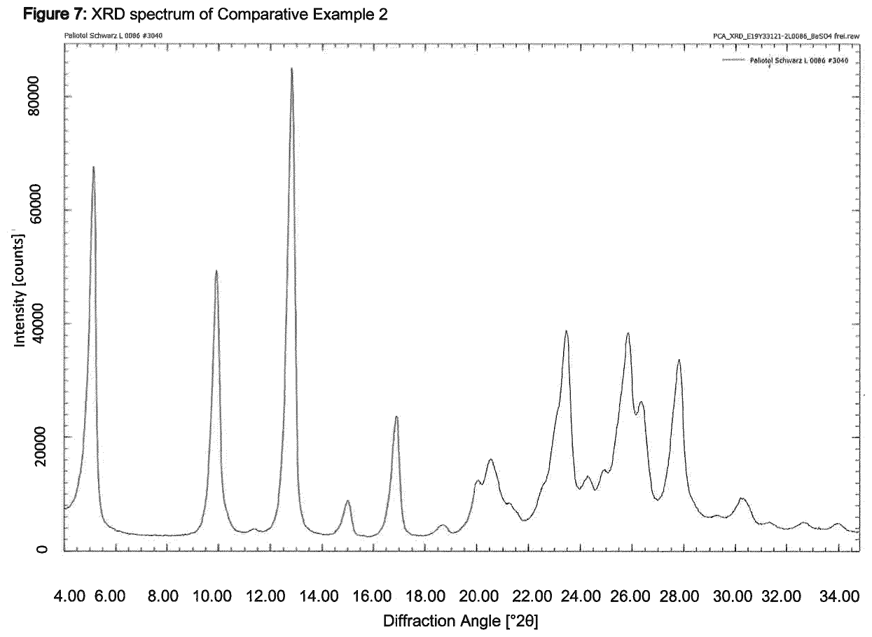

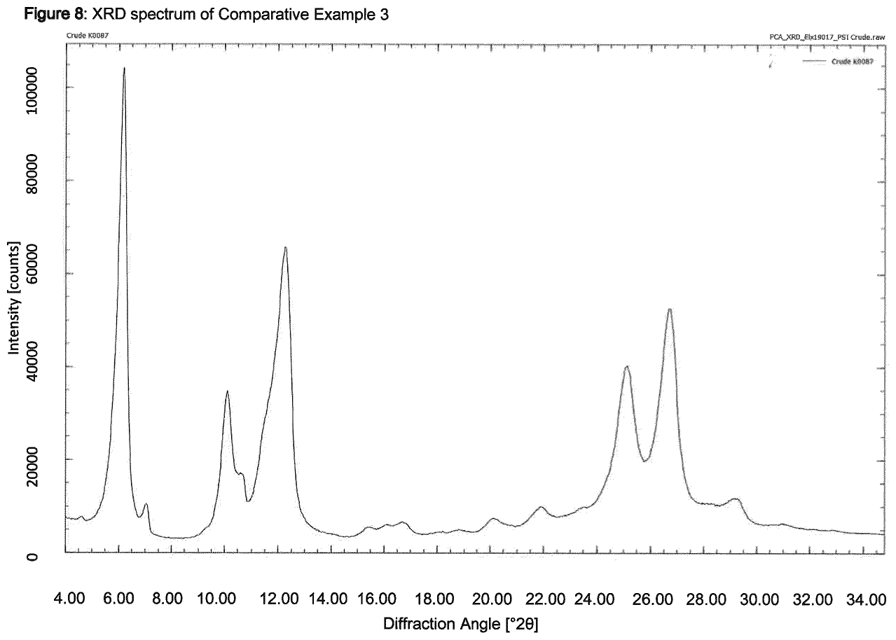

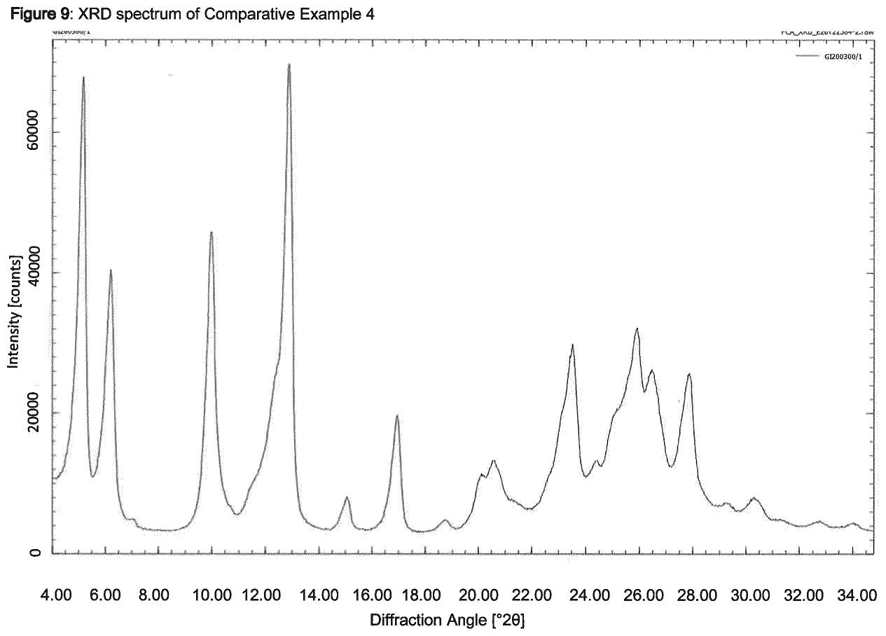

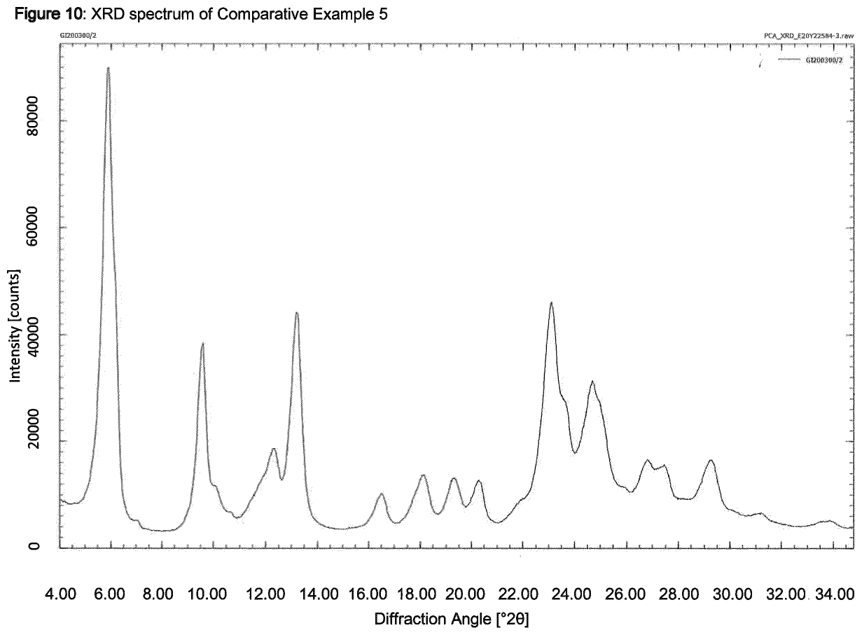

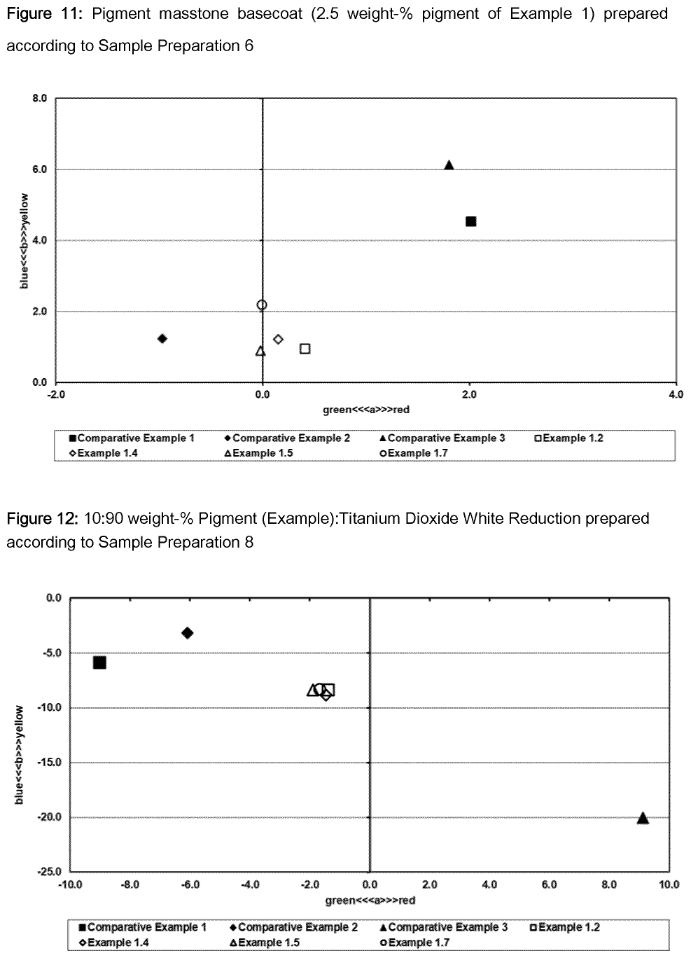

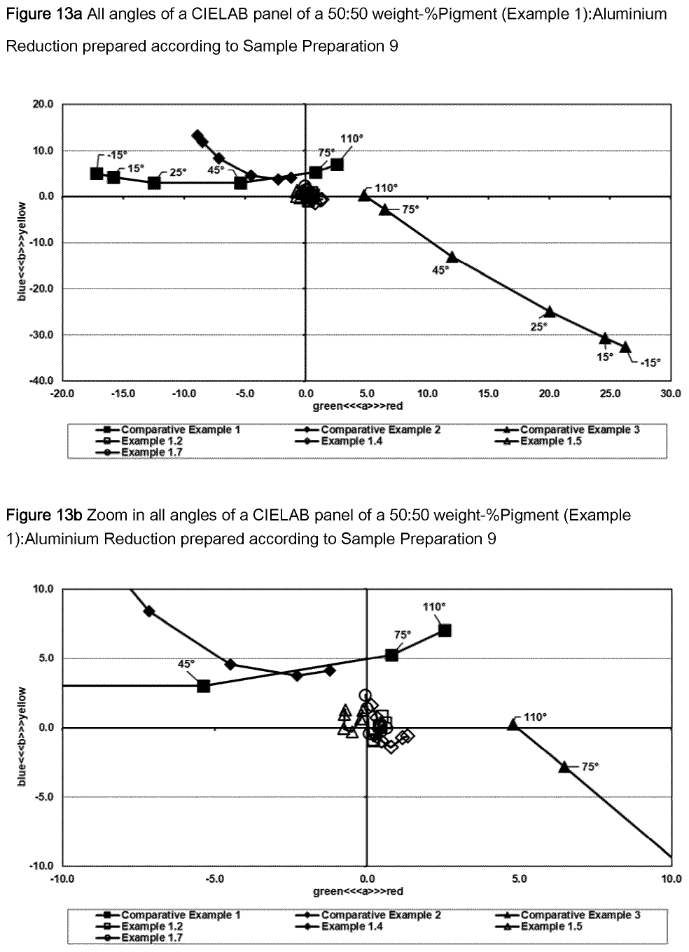

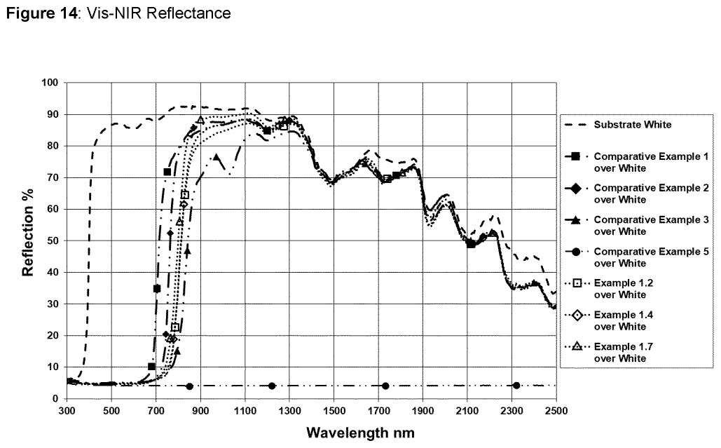

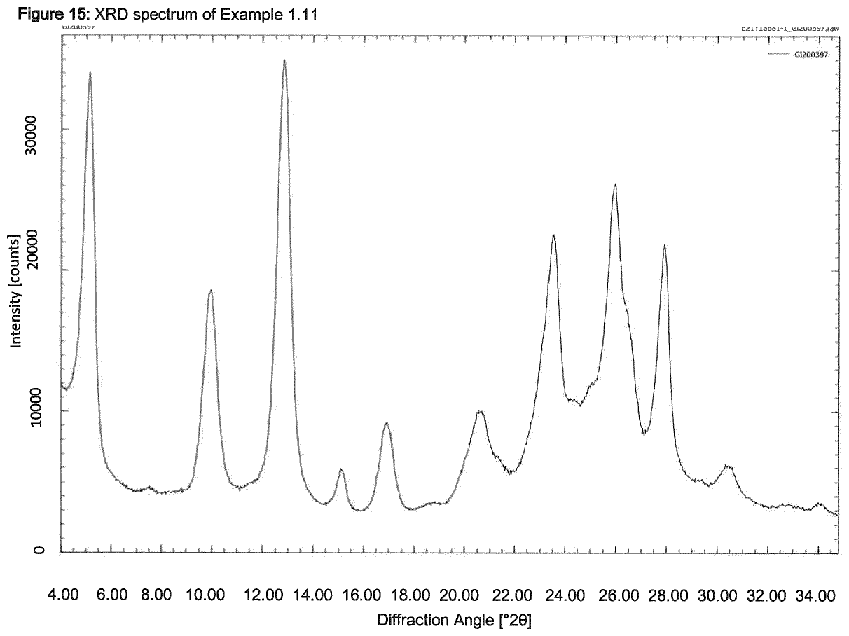

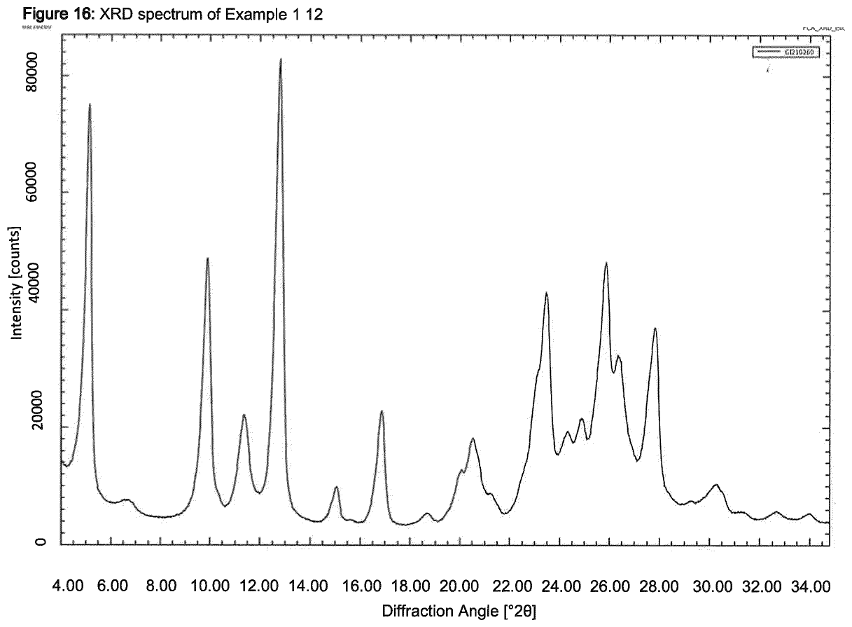

### LIST OF CITED PRIOR ART

WO2018/081613
U.S. Pat. No. 7,083,675
EP0636666B1
WO91/02034A1
EP2316886A1 EP504922A1
US2012018687A1
CN110591445A
Justus Liebigs Annalen der Chemie, 1984, 483
U.S. Pat. No. 4,450,273
US 2010/0184983A1

1. A solid solution comprising
(a) a compound according to formula (I) 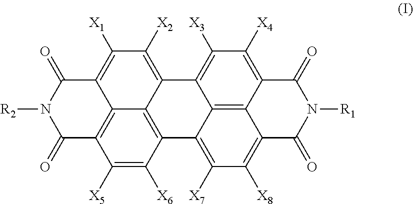
and
(b) a compound according to formula (II), or a compound according to formula (III), or a mixture of a compound according to formula (II) and a compound according to formula (III) 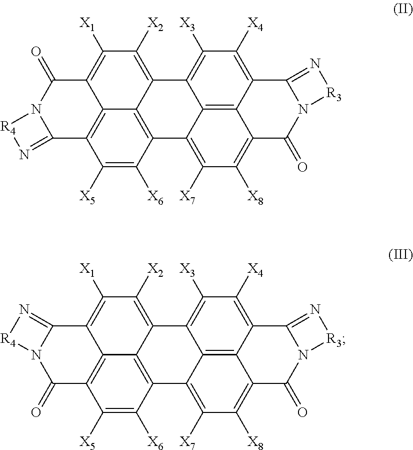
wherein
R₁ and R₂ are independently of one another —(CH₂)ₙ—X, wherein X is hydrogen, methyl, a C₁-C₅ alkoxyl, hydroxy, phenyl, C₁-C₅ alkylphenyl, C₁-C₅ alkoxyphenyl, hydroxyphenyl, halogenated phenyl, pyridyl, C₁-C₅ alkylpyridyl, C₁-C₅ alkoxypyridyl, halogenated pyridyl, pyridylvinyl or naphthyl; wherein n is 0, 1, 2, 3, 4 or 5;
R₃ and R₄ are independently of one another phenylene, C₁-C₅ alkylphenylene, C₁-C₅ alkoxyphenylene, hydroxyphenylene, halogenated phenylene, pyridinediyl, C₁-C₅ alkylpyridinediyl, C₁-C₅ alkoxypyridinediyl, halogenated pyridinediyl, anthraquinonediyl or naphthalenediyl, wherein the 2 nitrogen atoms bound to R₃ according to formula (II) and (III) form a 5-membered or a 6-membered heterocycle with 2 atoms of an aromatic ring of R₃; wherein the 2 nitrogen atoms bound to R₄ according to formula (II) and (III) form a 5-membered or a 6-membered heterocycle with 2 atoms of an aromatic ring of R₄;
X₁ to X₈ are independently from one another hydrogen, C₁-C₅ alkyl, C₁-C₅ alkoxy, hydroxy, phenyl or halide.

2. The solid solution of claim 1, wherein
X is methoxyphenyl or phenyl and n is 1 or 2;
R₃ and R₄ are independently of one another phenylene, methyl-phenylene, methoxyphenylene, chloro-phenylene, dichloro-phenylene or naphthalenediyl; and
X₁ to X₈ are hydrogen.

3. The solid solution of claim 1, wherein
R₁ and R₂ are independently from one another —CH₂C₆H₄OCH₃ or —CH₂CH₂C₆H₅;
R₃ and R₄ are independently of one another phenylene, 4-chloro-phenylene, naphthalenediyl or 4,5-dichloro-phenylene; and
X₁ to X₈ are hydrogen.

4. The solid solution of claim 1, wherein
X is 4-methoxyphenyl and n is 1;
R₃ and R₄ are phenylene; and
X₁ to X₈ are hydrogen; and/or
X is 4-methoxyphenyl and n is 1;
R₃ and R₄ are naphthalenediyl; and
X₁ to X₈ are hydrogen; and/or
X is 4-methoxyphenyl and n is 1;
R₃ and R₄ are 4-chloro-phenylene; and
X₁ to X₈ are hydrogen; and/or
X is 4-methoxyphenyl and n is 1;
R₃ and R₄ are 4,5-dichloro-phenylene; and
X₁ to X₈ are hydrogen; and/or
X is phenyl and n is 2;
R₃ and R₄ are phenylene; and
X₁ to X₈ are hydrogen; and/or
X is phenyl and n is 2;
R₃ and R₄ are naphthalenediyl; and
X₁ to X₈ are hydrogen; and/or
X is phenyl and n is 2;
R₃ and R₄ are 4-chloro-phenylene; and
X₁ to X₈ are hydrogen.

5. The solid solution of claim 1, exhibiting a non-color depending black value M_{Y} in the range of from 200 to 350, and a color depending black value M_{C} in the range of from 200 to 350, M_{Y} and M_{C} being determined according to DIN EN 18314-3.

6. The solid solution of claim 1, wherein in the solid solution, the weight ratio of the compound of formula (I) relative to the compound according to formula (II) or to the compound according to formula (III) or to the mixture of a compound according to formula (II) and a compound according to formula (III), weight((I)):weight((II)(III)), is in the range of from 60:40 to 99:1.

7. The solid solution of claim 1, wherein from 80 to 100 weight-% of the solid solution consist of
(a) the compound according to formula (I) and
(b) the compound according to formula (II), or the compound according to formula (III), or the mixture of the compound according to formula (II) and the compound according to formula (III).

8. A process for producing a solid solution, comprising
(i) providing a mixture comprising
(a) a compound according to formula (I) 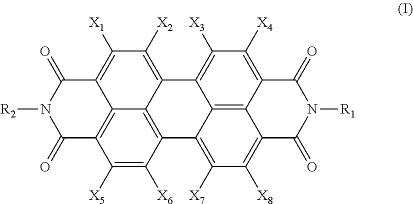
and
(b) a compound according to formula (II), or a compound according to formula (III), or a mixture of a compound according to formula (II) and a compound according to formula (III) 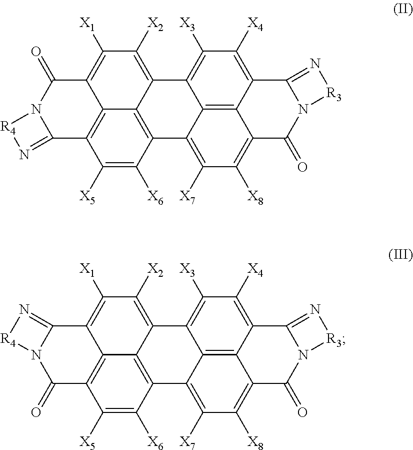
wherein
R₁ and R₂ are independently of one another —(CH₂)ₙ—X, wherein X is hydrogen, methyl, a C₁-C₅ alkoxyl, hydroxy, phenyl, C₁-C₅ alkylphenyl, C₁-C₅ alkoxyphenyl, hydroxyphenyl, halogenated phenyl, pyridyl, C₁-C₅ alkylpyridyl, C₁-C₅ alkoxypyridyl, halogenated pyridyl, pyridylvinyl or naphthyl; wherein n is 0, 1, 2, 3, 4 or 5;
R₃ and R₄ are independently of one another phenylene, C₁-C₅ alkylphenylene, C₁-C₅ alkoxyphenylene, hydroxyphenylene, halogenated phenylene, pyridinediyl, C₁-C₅ alkylpyridinediyl, C₁-C₅ alkoxypyridinediyl, halogenated pyridinediyl, anthraquinonediyl or naphthalenediyl, wherein the 2 nitrogen atoms bound to R₃ according to formula (II) and (III) form a 5-membered or a 6-membered heterocycle with 2 atoms of an aromatic ring of R₃; wherein the 2 nitrogen atoms bound to R₄ according to formula (II) and (III) form a 5-membered heterocycle with 2 atoms of an aromatic ring of R₄;
X₁ to X₈ are independently from one another hydrogen, C₁-C₅ alkyl, C₁-C₅ alkoxy, hydroxy, phenyl or halide;
(ii) subjecting the mixture provided according to (i) to mechanical treatment;
(iii) adding water to the mixture obtained from (ii);
(iv) subjecting the mixture obtained from (iii) to solid-liquid separation;
(v) washing the solids obtained from (iv) with a suitable washing agent; and
(vi) drying the solids obtained from (v), obtaining the solid solution.

9. The process of claim 8, wherein the mechanical treatment comprises one or more kneading and milling, wherein kneading comprises coextrusion, salt kneading, single-shaft kneading and double-shaft kneading and wherein milling comprises wet milling, ball milling, bead milling, vibration milling, planetary milling and attritor milling.

10. The process of claim 9, wherein the mechanical treatment is kneading, wherein said kneading is carried out at a temperature of the mixture in the range of from 40 to 120° C.

11. The process of claim 9, wherein the mechanical treatment further comprises, either directly before and/or during kneading, adding one or more of a synergist comprising sulfonic and carboxylic acid derivatives of perylene, indanthrone, phthalocyanine and diketopyrrolopyrrole.

12. The process of claim 9, wherein the mechanical treatment comprises milling, wherein said milling is carried out at a temperature of the mixture in the range of from 40 to 120° C.

13. The process of claim 12, wherein the process further comprises, directly after milling, adding a suitable acid or solvent to the milled mixture under stirring at a temperature of the mixture in the range of from 40 to 200° C.

14. A solid solution obtained by a process according to claim 8.

15. An article comprising-a solid solution according to claim 1, wherein the article is selected from the group consisting of a coating composition, a light detection and ranging (LiDAR) device, a near-infrared (NIR) non-absorbing component, a photovoltaic component, a heat management component, a thermal insulation component, a coloring paint, a printing ink, a recyclable plastic article, a biodegradable mulch, a toner, a charge-generating material, a color filter, a LC display and a security print component.

16. A method to increase the signal to noise ratio in nearinfrared (NIR) radiation detection in a coating or object, comprising replacing the nearinfrared (NIR) absorbing black pigments in the coating or object with a solid solution of claim 1.

17. A multilayer coating comprising:
a primer coating comprising a solid solution according to claim 1 and a white pigment or a reflective pigment having a reflectance of >50% in the range of 700 to 2500 nm, in a weight ratio of from 1:99 to 99:1;
a basecoat comprising a black color, metallic or interference pigment; and
optionally a clear topcoat.

18. A solid solution according to claim 1, comprised in one or more of a thermoplastic, elastomeric, crosslinked or inherently crosslinked polymer, in an amount from 0.01 weight % to 70 weight-% based on the total weight of the polymer.

19. The solid solution of claim 5, exhibiting a non-color depending black value M_{Y} in the range of from 220 to 330, and a color depending black value M_{C} in the range of from 220 to 330, M_{Y} and M_{C} being determined according to DIN EN 18314-3.

20. The solid solution of claim 19, exhibiting a non-color depending black value M_{Y} in the range of from 230 to 300 and a color depending black value M_{C} in the range of from 242 to 280, M_{Y} and M_{C} being determined according to DIN EN 18314-3.
